(19) United States
(12) Patent Application Publication
(10) Pub. No.: US 2024/0393758 A1
(43) Pub. Date: Nov. 28, 2024

(54) SYSTEM AND METHOD FOR INTELLIGENT ELECTRONIC SAFETY RESPONSE INTERFACE

(71) Applicants: Marc Goldsmith, Boca Raton, FL (US); Abraham Wien, Boca Raton, FL (US)

(72) Inventors: Marc Goldsmith, Boca Raton, FL (US); Abraham Wien, Boca Raton, FL (US)

(21) Appl. No.: 18/202,390

(22) Filed: May 26, 2023

(51) Int. Cl. G05B 19/042

(52) U.S. Cl. CPC G05B 19/0428; G05B 2219/2639

(57) ABSTRACT

An Electronic Safety Response Interface (EsRi) system, including: at least two major processors inclusive of an EsRi intelligence server node (processor)—connected to a EsRi Control processor over a network and configured with multiple modules. The EsRi Intelligence server node analyzes the sensory data to derive a plurality of features; queries the interconnected electric energy grid and database, generates at least one feature vector based on the plurality of features; uses numerous other data sources; and provides at least one feature vector to the machine learning module creating a predictive real-time model providing at least one programming parameter to the Safety and Risk Assessment (SaRa) rating system. The resulting vector is used for by EsRi Control processor activating pre-programmed control sequences corresponding to SaRa vectors using electric energy grid sensory and attached electric generation and/or storage systems data managing the control system and electric energy flow while isolating the electric system flaw.

### FIELD OF DISCLOSURE

The subject invention relates to a computerized electronic and control system that facilities a safe and reliable single point of utility interconnection for one or more generation or storage technologies to the electric energy grid, defined herein as an interconnected network for delivery of electricity from generators to consumers. More specifically, this invention combines two operative functions, or components, referenced collectively as an “Electronic Safety Response Interface,” or “EsRi,” and provides a graphical user interface (GUI) providing a predictive safety and risk assessment scorecard, referenced herein as “SaRa,” that visually and electronically informs control sequences that facilitate a safe and reliable electric energy grid interconnection, including under a variety of failure modes. The EsRi system interface brings together two components or modules: One, termed EsRi Intelligence, gathers information and uses machine language (ML) and artificial intelligence (AI) from multiple electric energy grid and external data sources to predict the risk of failure of the electric energy grid as well as the amount of power and nature of ancillary services to be provided by the generation and/or storage facility; and, Two, termed EsRi Control, which gathers information from the individual generation or storage components, and in conjunction with information synthesized through EsRi Intelligence, provide a real-time SaRa assessment to select pre-sequenced control actions to protect the electric energy grid and associated energy systems while maintaining a flow of electricity during a failure thus assuring secure, reliable and predictable delivery of electricity to the electric energy grid. EsRi is designed to satisfy an increasingly important need during the complex systems transition to renewable energy generators, whose production is intermittent and are incapable of supplying all the necessary attributes of a high quality and reliable electric energy grid.

### BACKGROUND

The world is at a critical juncture where the shift from synchronous non-renewable energy sources, including fossil fuels, coal, petroleum, natural gas and publicly unacceptable nuclear power plants, to intermittent, non-dispatchable renewable energy sources, including photovoltaic and windmills, is imperative to mitigate climate change. While the transition to renewable energy resources is imperative to accomplish as soon as possible, there are multifaceted issues that need to be addressed to make this transition successful, efficient and effective while also ensuring a sustainable and reliable electric energy grid.

The Federal government has a stipulated goal of being net-zero carbon by 2050 and most States have similar mandates. Accordingly, the U.S. Energy Information Administration (EIA) now expects U.S power generation from renewable sources to increase from 21% in 2021 to 44% of total electricity generation by 2050. This increase in renewable energy mainly consists of new solar and wind power generation with the contribution from hydropower remaining largely unchanged and geothermal and biomass generation remaining less than 3% of total generation. The increasing penetration of renewables is leading to deterioration in the reliability of the electric energy grid and greater fluctuations in power prices as the power output of renewable sources such as solar and wind are not consistent-solar arrays generate little power on cloudy days and no power when the sun is down, and wind generates little power at times without wind and too much power when there is a lot of wind or solar generators are producing at full capacity. For example, the electric energy grid needs to have a system frequency that is on average near the scheduled frequency value at 60 Hz. When frequency increases above the scheduled value due to over-generation relative to demand it can lead to electric energy grid instability. Further, if demand for electricity increases faster than generation can supply, it will lead to electric energy grid instability (when frequency decreases below the scheduled value because demand for electricity exceeds the generation relative to the load on an electric energy grid).

Maintaining the reliability and stability of the electric energy grid is essential to ensure a continuous and secure supply of electricity to consumers. It involves a combination of technical measures, operational strategies, regulations, and ongoing monitoring. This is accomplished through rigorous planning and design processes that are undertaken to ensure that the electric energy grid is capable of meeting present and future demands. Significant infrastructure upgrades are required to address the operational needs of an evolving electric energy grid. This includes upgrading existing transmission lines to incorporate distributed energy resources and building new lines to improve wholesale market operations, increase resilience and bring energy from remote renewable resources to population centers. The distribution grid-which carries energy to individual homes and businesses at the local level-will need even more investment than the transmission system. Sixty percent of U.S. distribution lines have surpassed their 50-year life expectancy; according to Black and Veatch, while the Brattle Group estimates that $1.5 trillion to $2 trillion will be spent by 2030 to modernize the electric energy grid just to maintain reliability.

A Princeton University study established a set of measures needed in the ten years ending 2030 that includes growing wind and solar electricity generating capacity fourfold (to approximately 600 gigawatts), enough to supply roughly half of U.S. electricity, and, in addition to replacing the dated distribution lines, expand the high-voltage transmission capacity by roughly 60% to deliver renewable electricity to where it is needed. Further, the Princeton study anticipates that total electricity demand will more than double by 2050-adding to the amount of new renewable energy installations needed over the next 25 years.

As more customers deploy distributed energy resources, some communities are seeing a fundamental shift in energy management, with large, distant generation sources being replaced by smaller, modular and local sources. Creating a more complex yet flexible system—where customers can also be energy producers, energy managers and market participants-will require a much more adaptable and technologically advanced electric energy grid. Developing a more dynamic electric energy grid that can absorb and use the rapid expansion of distributed energy resources (small-scale renewable generation) and other energy solutions will require advanced electric energy grid management and control technologies, digital controls and communications, new analytics and supportive regulatory approaches.

New generation and storage projects must apply for an interconnection with the electric energy grid operator; after which the proposed facility is studied for the impacts on the electric energy grid. Reports by both MIT and Deloitte as well as other industry experts indicate that one of the major obstacles to adding intermittent renewable energy resources to the electric energy grid is the interconnection to the transmission system. Deloitte notes that at the end of 2020, “About 844 GW of proposed capacity-90% of which is renewables or energy storage—is stuck in transmission interconnection queues. This holds especially true for offshore wind, which is poised for significant growth and must be connected to coastal (electric) infrastructure.” Further, for four independent system operators (ISOs) where data is available, the time new energy generation and storage projects spent in queues before being built increased from approximately 1.9 years for projects built between 2000 and 2009 to around 3.5 years for those built between 2010 and 2020. Finally, for five ISOs where data was available, only 24% of projects in the queues reached commercial operations with only 19% of wind and 16% of solar projects having been completed.

Further, with regard to the addition of new generation and storage facilities, the upfront interconnection costs, as well as the timing of conducting feasibility studies, technical assessments, environmental impact studies and obtaining various regulatory approvals, associated with these projects are an impediment to the transition to renewable energy. In a June 2023 report on the “Generator Interconnection costs to the Transmission System,” Lawrence Berkeley National Laboratory reports that “average interconnection costs have grown across all regions and often doubling for projects that have completed all studies” and “increasing even more for active projects currently moving through the queues.” In a New York Independent System Operator (NYISO) study, costs tend to increase as projects complete more studies. The costs of feasibility-to-system impact studies have increased up to 25% for a majority of projects while system impact-to-facilities studies have increased more than 100% for more than 25% of projects. And the Independent System Operator-New England (ISO-NE) reports that onshore wind and solar interconnection costs have more than doubled since 2018 resulting in 81% of the wind projects studied withdrawing from the process. Other electric. Energy grid operators report similar cost and timing increases.

To compensate for the intermittent, and unreliable, production of electricity by solar and wind generators, operators have increasing paired a generation facility and a battery energy storage system (BESS) co-located on one site. The addition of these “hybrid” facilities is anticipated to accelerate as the Inflation Reduction Act allows storage to qualify for investment tax credits (ITCs) whereas previously only the solar and wind generation component was qualified for ITCs. According to another study published by the Lawrence Berkeley National Laboratory in April 2022 finds that “Combining the characteristics of multiple energy, storage, and conversion technologies poses complex questions for (electric energy) grid operations and economics. Project developers, system operators, planners, and regulators would benefit from better data, methods, and tools to estimate the costs, values, and system impacts of hybrid projects. The opportunity for hybrids is clearly large as we move toward greater levels of renewable energy, but their implications and optimal applications have yet to be established.”

Relative to the aforementioned hybrid facilities, they interface with the electric energy grid as either a single, fully integrated resource, or as two separate, but co-located, resources. As an integrated resource, the hybrid project operator has to forecast wind or solar electric output and manage its energy storage systems when developing market bids and interconnecting with the electric energy grid. Managed as separate resources, the operator has two interconnection points with wholesale market operators needing to develop and implement methods to manage the dispatch of batteries and the variability of the wind or solar while accounting for any coupling constraints. Developers and market operators will evaluate the cost and revenue implications of each model. Currently, the separate but co-located model is the most popular option in California. However, in cases where hybrids aim to follow dispatch signals beyond wholesale market prices (e.g., reducing peak loads, incentive program payments, or resiliency benefits), hybrid project owners may favor the high level of autonomy offered by the fully integrated model. Both hybrid and co-located facilities require sophisticated control systems to interconnect with the electric energy grid.

In April 2022, the Federal Energy Regulatory Commission (FERC or Commission) issued a Notice of Proposed Rulemaking (NOPR) with a goal of improving regional electric transmission planning and cost allocation. FERC is an independent Federal agency that regulates the transmission and wholesale sale of electricity and natural gas in interstate commerce among other responsibilities, plays a critical role in the evolution of the electric energy grid. The NOPR proposes a more detailed affected systems study process, including a specific modeling standard and pro forma affected system agreements. The NOPR also proposes reforms to administratively simplify the process of studying interconnection requests that are all related to the same state-authorized or mandated resource solicitation. In addition, the NOPR also proposes to allow interconnection customers to add a generating facility to an existing interconnection request under certain circumstances without automatically losing their position in the queue. In addition, the NOPR proposes to require transmission providers to consider alternative transmission solutions if requested by the interconnection customer. Finally, for system reliability the NOPR proposes certain modeling and performance requirements for non-synchronous (renewable) generating facilities to address the unique characteristics of the changing resource mix. For example, to ensure that non-synchronous resources are better able to support reliability, the NOPR proposes to require them to continue providing power and voltage support during electric energy grid disturbances.

Accordingly, the EsRi system interface is designed to facilitate more cost-effective and efficient interconnection processes, allow electric energy grid operators and planners to have confidence in the reliability and stability of the electric power being distributed onto the electric energy grid from the generation and/or storage facility and reduce the number of instances when the generation and/or storage facility is off-line. Accordingly, EsRi is configured to control the perturbations of the non-synchronous generating facility and storage modalities that exist at the interconnection point.

### BRIEF OVERVIEW

This Brief Overview provides a non-technical introduction to the Electronic Safety Response Interface (“EsRi”) system, a set of software programs and, potentially, hardware, that manages the facility interconnection and is comprised of two parts: EsRi Intelligence and EsRi Control. EsRi Intelligence utilizes artificial intelligence (AI)-enabled algorithms collecting data from disparate sources to create predictive conditions existing on the electric energy grid; thereby facilitating a risk assessment and response mechanism. EsRi Intelligence interfaces with EsRi Control which simultaneously monitors the capacity, functionality and availability of the facility's generation/storage resources including contractual obligations and responds to the inputs to operate protective relaying using pre-programmed control sequences triggered by EsRi Intelligence. EsRi Intelligence synchronously informs electric energy grid operators and facility operations management through a Safety and Risk Assessment Rating System (“SaRa”) thereby minimizing risk to the electric energy grid, optimizing the electric energy grid performance and maximizing facility functionality and profitability. This brief overview is not intended to identify key features or essential features of the claimed subject matter; nor is this brief overview intended to be used to limit the claimed subject matter's scope.

EsRi is a networked and integrated series of computer software program that uses multiple complex data sets to forecast risks to the electric energy grid and the energy generation and/or energy storage systems and selects preprogrammed automated responses to a series of initiating events that could impede the flow of electricity to the electric energy grid from an energy generation and/or storage facility. EsRi Intelligence is programmed to seek, collect, analyze and use data from a broad range of sources beyond the information powering the protective relay systems. EsRi Intelligence collects and “learns” from weather forecasts and weather forecast performance, operating status of energy trading platforms, state of the electric energy grid at the injection point and overall, predictive maintenance models, in addition to the standard protective electric energy grid relaying information and a myriad of other sources. It continually processes both long- and short-term data to develop predictive initiators for learnable parameters to forecast the level of electric energy grid failure risk and informs the corresponding control sequences necessary to autonomously maintain energy generation and/or storage performance during a variety of facility system failures. ESRI Intelligence uses the massive quantities of data generated by the sensors and other systems in an AI module to learn from the sensors, existing models and control software, data and control systems, as appropriate to anticipate and predict electric systems performance and response to different electrical events allowing EsRi Control to respond autonomously. EsRi Intelligence also supports the electric generating and/or storage facility business models with scheduling, financial planning, and strategic insight that helps reduce the overall system risk levels through better planning and operation while maximizing value.

EsRi Control overlays the protective relaying system to be able to initiate sequences that maintain power flow if specific storage devices are unable to provide power. EsRi Control receives an interconnection risk signal reflecting the fragility of the electric energy grid system, and initiates control sequences to keep power flowing from other storage devices, while isolating the perturbed device, allow other devices to maintain electric energy flow and/or provide ancillary services to the electric energy grid. EsRi Control then controls the generation and/or storage systems through protective relay actions programmed to properly maintain the interconnection voltage, current and frequency within the limits of the generation/storage facility and the electric energy grid interconnection point. EsRi Control makes a range of electric generation and/or storage modalities to look electrically the same to the electric energy grid, thereby, making the system planning easier.

Safety and Risk Assessment Rating System (“SaRa”), informed by both EsRi Intelligence and EsRi Control, analyzes and reports based on a set of standards and factors that create risks associated with the electric energy grid and/or the electric generation and/or storage facility. Through the EsRi Intelligence AI, SaRa codifies the risk and sets the hierarchy for protective, operational, safety and reliability actions under the multifactor scenarios in both predictive and real time. The SaRa ratings, which measures the risk to the electric energy grid; provides a standardized digital and human interface framework to inform electric energy grid managers and the facility management of the level of risk in the interconnection.

Both the foregoing Brief Overview and the following description of the drawings and detailed technical description provide examples and are explanatory only. Accordingly, the foregoing Brief Overview and the following Detailed Description should not be considered to be restrictive. Further, features or variations may be provided in addition to those set forth herein. For example, embodiments may be directed to various feature combinations and sub-combinations described in the Detailed Description.

### DESCRIPTION OF THE DRAWINGS

The EsRi system invention is further described by way of example with reference to the accompanying drawings, which are incorporated in, and constitute a part of this disclosure, which illustrates various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a network diagram of a system for an intelligent EsRi consistent with the present disclosure;

FIG. 1B illustrates a network diagram of a system for an intelligent EsRi consistent with the present disclosure using a “Blockchain” which for purposes of the present disclosure means “a secure digital ledger recording system to assure that the shared EsRi Intelligence and EsRI Control data systems are secure, consistent and synchronized for implementation of the specific needs of the system status and controls that are connected to electric energy grid” (“Blockchain”);

FIG. 2 illustrates a network diagram of a system including detailed features of an EsRi Intelligence server node consistent with the present disclosure;

FIG. 3A illustrates a flowchart of a method for an intelligent EsRi system consistent with the present disclosure;

FIG. 3B illustrates a further flow chart of a method for the intelligent EsRi system consistent with the present disclosure;

FIG. 4 illustrates deployment of a machine learning model for prediction of EsRi controller programming parameters using Blockchain programs consistent with the present disclosure;

FIG. 5 illustrates an architecture of the EsRi system consistent with the present disclosure;

FIG. 6 illustrates type of data inputs that may be deployed by the EsRi system consistent with the present disclosure;

FIG. 7 illustrates a further arrangement of elements of the intelligent EsRi system including EsRi controller consistent with the present disclosure;

FIG. 8 illustrates an example of AI processing within the intelligent EsRi system consistent with the present disclosure;

FIG. 9 illustrates examples of functionality of an EsRi Intelligence server consistent with the present disclosure;

FIG. 10 illustrates generation of risk status inputs of the EsRi controller consistent with the present disclosure;

FIG. 11 illustrates an example of ESS employing the EsRi system consistent with the present disclosure;

FIG. 12 illustrates exemplary implementation of the EsRi system with multi-modal electricity generation and/or storage control and protective relays consistent with the present disclosure;

FIG. 13 illustrates exemplary implementation of the EsRi system Actuator Control Flow consistent with the present disclosure;

FIG. 14 illustrates exemplary implementation of the EsRi system Control Flow for Lithium Fault consistent with the present disclosure;

FIG. 15 illustrates exemplary implementation of the EsRi system Control Flow for Flow Battery consistent with the present disclosure;

FIG. 16 illustrates exemplary implementation of the EsRi system Control Flow for Switchgear Fault consistent with the present disclosure;

FIG. 17 illustrates a block diagram of a system including a computing device for performing the method of FIGS. 3A and 3B.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for executing the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in a variety of sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

This Detailed Description includes reference to the accompanying drawings which were previously summarized. Wherever possible, the same reference numbers are used in the drawings and this description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of processing job applicants, embodiments of the present disclosure are not limited to use only in this context.

The present disclosure provides a computer software system that provides for an intelligent EsRi (“EsRi Intelligence”) informing and using an EsRi controller (“EsRi Control”).

In one embodiment of the present disclosure, the EsRi system provides for AI and machine learning (ML)—generated list of programming parameters to be used for re-configuration of EsRi Control of an electric energy grid interconnection. In one embodiment, an automated decision model may be generated to provide for identification of the most optimal settings of EsRi Control based on the current conditions including, but not limited to weather, state of the electric energy grid, state of the market, loads, pricing and contracts, etc. The automated decision model may use historical electric energy grid-related data collected at the current electric energy grid and on other electric energy grids of the same type located at locations of similar topology.

In one disclosed embodiment, the AI/ML technology may be combined with a self-contained Blockchain technology for secure use of EsRi controller configuration data. The disclosed embodiment may produce a detailed safety score on the accident (e.g., overloads) occurrence likelihood at the current electric energy grid setting. This allows for direct reporting on the trust level of the particular electric energy grid to the energy authorities. In one embodiment, the energy authorities may be connected to the EsRi intelligence server over a Blockchain network to achieve a consensus prior to executing a transaction to release the new configuration settings for a particular EsRi controller connected to the particular electric energy grid.

According to the disclosed embodiments, the Electronic Safety Response Interface (EsRi) System for a multi-modal electric generation and/or storage facility is a solution that facilitates the electric energy grid of the future. The disclosed EsRi system enables a non-synchronous generation and co-located, hybrid or stand-alone Energy Storage System (ESS) to deliver a wide range of applications, including load-shifting, frequency regulation and other ancillary services as well as the ability to provide long-duration storage with a consistent interface with the electric energy grid.

The disclosed EsRi system simplifies the process of multi-modal interconnection generation and/or ESS by making the interconnection from the generation and/or ESS side more standardized and easier to model. Improving the interconnection process and subsequent analysis of generation facilities, a hybrid or co-located ESS serves to provide time-shifting and other electric energy grid ancillary services for intermittent generation power plants. As a transmission asset, an ESS may function as a electric energy grid reliability tool to smooth out unexpected events and shift electric load at locations other than generation facility interconnection point where the electric energy grid needs synchronous resources. Each multi-modal facility has a specific set of performance that demonstrates different electric characteristics. The EsRi interface smooths these characteristics to protect the electric energy grid, protect the facility equipment, and to provide the interface for scheduling and dispatch software that optimizes the facility, and especially the ESS, response while minimizing the impact of perturbations on the electric energy grid. Combined these EsRi features make it easier to model the interconnection interface reducing analysis time and improving reliability.

The disclosed EsRi system is a three-phase alternating current (AC) protection system designed to assure that all the electricity storage modalities in an EsRi protected facility will respond in an acceptable and uniform manner to electric energy grid perturbances thus, making electric energy grid planning and operations consistently predictable.

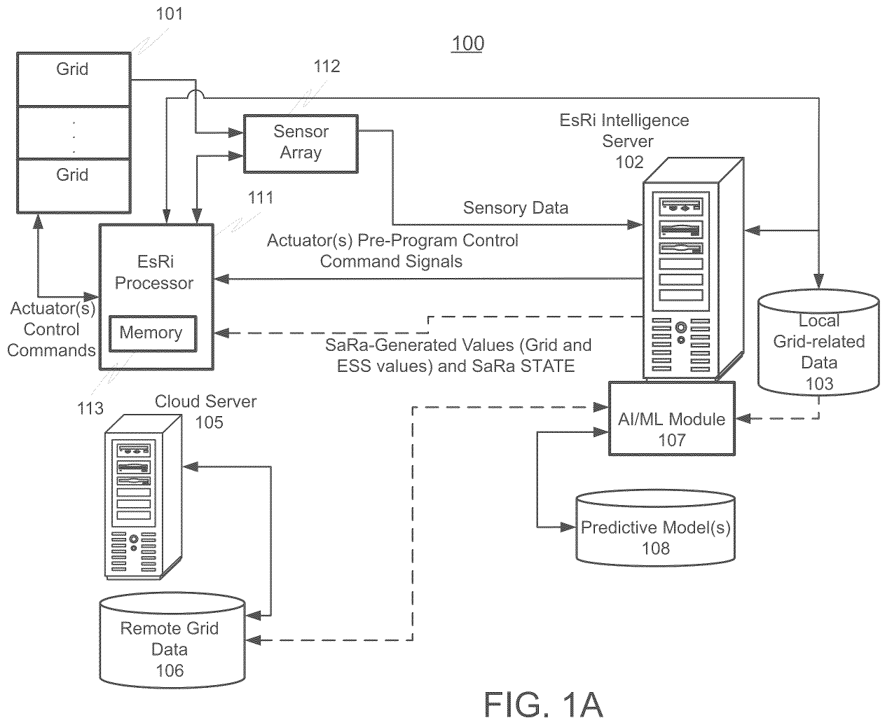

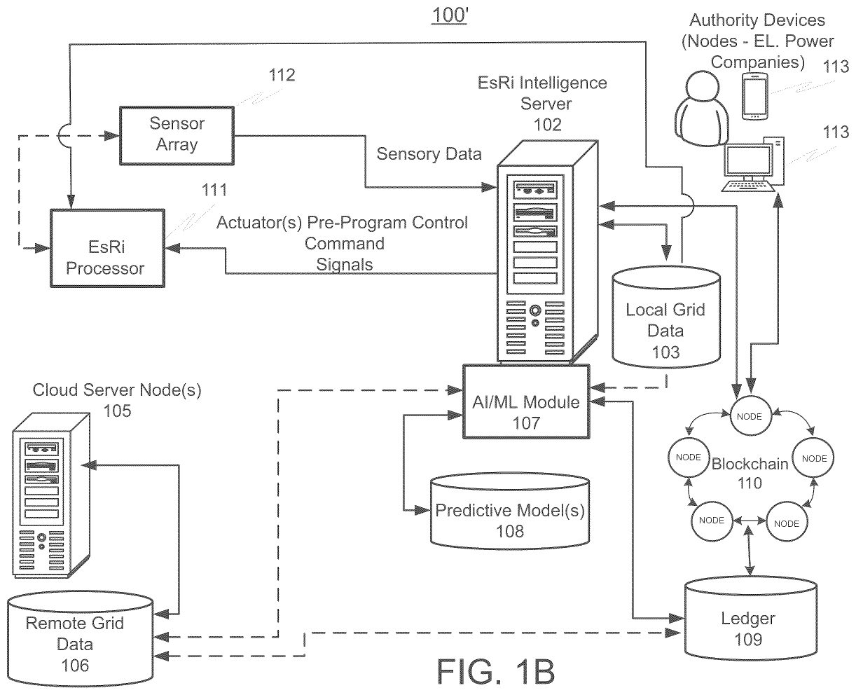

FIG. 1A illustrates a network diagram of a system for an intelligent EsRi system consistent with the present disclosure.

As discussed above, the purpose of the EsRi System is to maintain a safe, reliable interface between the electric energy grid 101 and a multi-modal generation/ESS facility under a variety of operating conditions. This requires sensing and ensuring circuit stability rapidly through a variety of perturbations by using sensors 112, relays, inductor and capacitor devices to maintain voltage, current, and frequency stability on the electric energy grid 101 under a variety of electric scenarios. In addition to providing interconnection planners a standardized set of parameters to simplify interconnection with the electric energy grid 101.

Referring to FIG. 1A, the example network 100 includes the EsRi Intelligence server node 102 connected to a cloud server node(s) 105 over a network. The EsRi Intelligence server node 102 is configured to host an AI/ML module 107. The EsRi Intelligence server node 102 may receive sensory data from an array of sensors 112. Note that the array of sensors 112 may be located on the electric energy grid 101 or on variety of structures located in the proximity of the electric energy grid 101. The EsRi Intelligence server node 102 may query a local electric energy grid-related database for the historical electric energy grid data 103 associated with the current date and time. The EsRi Intelligence server node 102 may acquire relevant remote electric energy grid-related data 106 from a remote electric energy grid database residing on a cloud server 105. The remote electric energy grid data 106 may be collected from electric energy grids of the same type located within a certain range of the electric energy grid 101.

The EsRi Intelligence server node 102 may generate a feature vector data based on the sensory data and the collected electric grid-related data (i.e., pre-stored local data 103 and remote data 106). The EsRi Intelligence server node 102 May ingest the feature vector data into an AI/ML module 107. The AI/ML module 107 may generate a predictive model(s) 108 based on the feature vector data to predict programming parameters for automatically programming the electric energy grid 101. The programming parameters may be provided to a programmable EsRi controller 111 with memory 113 operatively coupled to the electric energy grid 101. In one embodiment, the EsRi Intelligence server node 102 may send actuator pre-program control command signals to the EsRi controller 111.

The EsRi Intelligence server node 102 is implemented as a machine-learning (ML) system configured to predict (i.e., forecast) a risk from an generation and/or energy storage facility (not shown) to a specific point on the electric energy grid 101 and to create outputs in a form of control sequences that keep the electric generation and/or storage units in operation while providing reliable power during multiple electric energy grid 101 and facility malfunctions and electric perturbations.

The EsRi controller 111 may be configured to augment and supplement protective relaying system (not shown) typically connected to the electric energy grid 101 to maintain uninterrupted power flow under multiple risk scenarios and equipment failures without a human intervention. The EsRi controller 111 may be configured to overload and expand on the standard protective relaying control systems to provide a reliable electric path to the electric energy grid during electric generation fluctuations, and battery and/or other storage failures. The disclosed EsRi controller 111 may rely on expanded smart sensors 112 to provide rapid information to the control system to maintain reliable power flow to the electric energy grid under various events by segmenting the protective relaying responses commensurate with predicted risk.

The EsRi Intelligence server node 102 may provide a continuous learning process that outputs the expected (predicted) risk status of the connected system and aligns protective control sequences to maintain electric energy grid 101 interconnectional reliability under variety of scenarios where standard relaying does not operate to maintain circuit power flow. The EsRi Intelligence server node 102 may provide Safety and Risk Assessment (SaRa) generated values (i.e., electric energy grid and generation/ESS values along with a SaRa state value).

FIG. 1B illustrates a network diagram of a system for an intelligent EsRi consistent with the present disclosure using Blockchain computer software module consistent with the present disclosure.

Referring to FIG. 1B, the example network 100′ includes the EsRi Intelligence server node 102 connected to a cloud server node(s) 105 over a network. The EsRi Intelligence server node 102 is configured to host an AI/ML module 107. The EsRi Intelligence server node 102 may receive sensory data from an array of sensors 112. Note that the array of sensors 112 may be located on the electric energy grid 101 or on variety of structures located in the proximity of the electric energy grid 101. The EsRi Intelligence server node 102 may query a local electric energy grid-related database for the historical electric energy grid data 103 associated with the current date and time. The EsRi Intelligence server node 102 may acquire relevant remote electric energy grid-related data 106 from a remote electric energy grid database residing on a cloud server 105. The remote electric energy grid data 106 may be collected from electric energy grids of the same type located within a certain range of the electric energy grid 101.

The EsRi Intelligence server node 102 may generate a feature vector data based on the sensory data and the collected electric energy grid-related data (i.e., pre-stored local data 103 and remote data 106). The EsRi Intelligence server node 102 may ingest the feature vector data into an AI/ML module 107. The AI/ML module 107 may generate a predictive model(s) 108 based on the feature vector data to predict programming parameters for automatically programming the electric energy grid 101. The programming parameters may be provided to a programmable EsRi controller 111 operatively coupled to the electric energy grid 101.

The EsRi Intelligence server node 102 is implemented as a machine-learning (ML) system configured to predict (i.e., forecast) a risk from an electric generation and/or storage facility (not shown) to a specific point on the electric energy grid 101 and to create outputs in a form of control sequences that keep the electric generation and/or storage units in operation while providing reliable power during multiple electric energy grid 101 and facility malfunctions and electric perturbations.

The EsRi controller 111 may be configured to augment and supplement protective relaying system (not shown) typically connected to the electric energy grid 101 to maintain uninterrupted power flow under multiple risk scenarios and equipment failures without a human intervention. The EsRi controller 111 may be configured to oversee and expand on the standard protective relaying control systems to provide a reliable electric path to the electric energy grid during battery and/or other storage failures. The disclosed EsRi controller 111 may rely on expanded smart sensors 112 to provide rapid information to the control system to maintain reliable power flow to the electric energy grid under various events by segmenting the protective relaying responses commensurate with predicted risk.

In one embodiment, EsRi Intelligence server node 102 may receive the predicted programming parameters from a permissioned Blockchain 110 ledger 109 based on a consensus from energy authority devices 113. Additionally, confidential historical electric energy grid-related information and previous programming parameters may also be acquired from the permissioned Blockchain 110. The newly acquired sensory data with corresponding predicted programming parameters data may be also recorded on ledger 109 of the Blockchain 110 so it can be used as training data for the predictive model(s) 108. In this implementation EsRi Intelligence server node 102, the cloud server 105 and the energy authority devices 113 may serve as Blockchain 110 peer nodes. In one embodiment, local electric energy grid-related data 103 and remote electric energy grid-related data 106 may be duplicated on the Blockchain ledger 109 for higher security of storage.

The AI/ML module 107 may generate a predictive model(s) 108 to predict the programming parameters for the EsRi controller 111 in response to the specific relevant pre-stored electric energy grid-related data acquired from the Blockchain 110. This way, the current programming parameters may be predicted based not only on the live sensory data received from the sensors 112, but also based on the previously collected sensory and electric energy grid-related data associated with the given electric energy grid or the grids of similar topology located within a certain distance range within the area that has similar weather conditions.

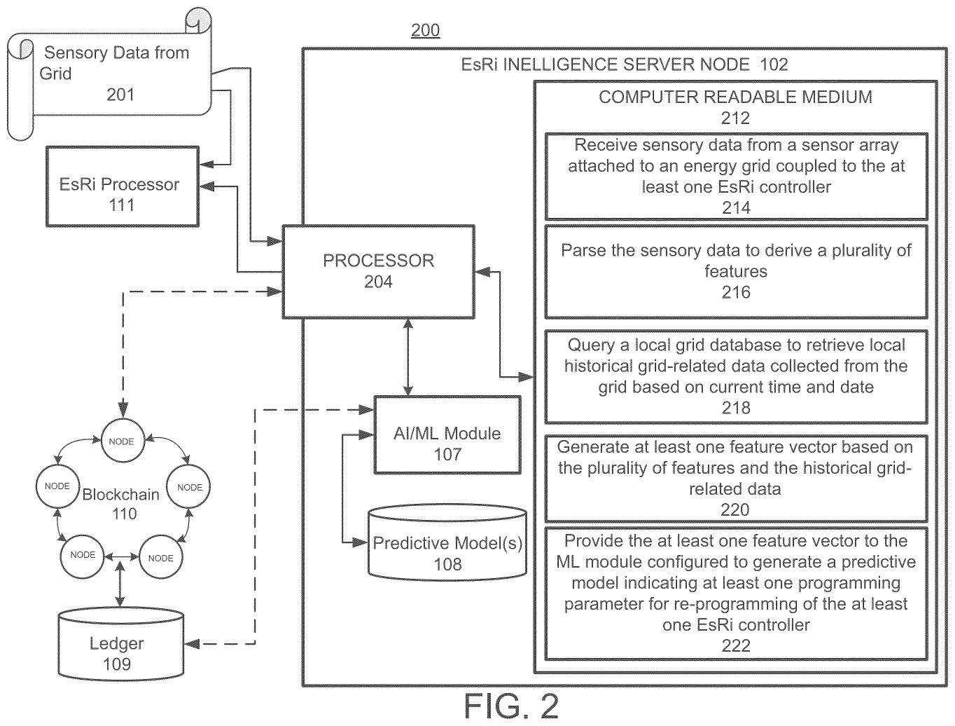

FIG. 2 illustrates a network diagram of a system including detailed features of the EsRi Intelligence server node consistent with the present disclosure.

Referring to FIG. 2, the example network 200 includes the EsRi Intelligence server node 102 connected to a EsRi controller 111 over a network (LAN or wireless). The EsRi Intelligence server node 102 is configured to host an AI/ML module 107. As discussed above with reference to FIGS. 1A-B, the EsRi Intelligence server node 102 may receive sensory data acquired from sensor array 112 and pre-stored electric energy grid-related data retrieved from local and remote databases. As discussed above, the pre-stored electric energy grid-related data may be retrieved from ledger 109 of Blockchain 110.

The AI/ML module 107 may generate a predictive model(s) 108 based on the received from the electric energy grid sensory data 201 and electric energy grid-related data provided by the EsRi Intelligence server node 102. As discussed above, the AI/ML module 107 may provide predictive outputs data in the form of programming parameters for automatic re-programming of the EsRi controller 111. The EsRi Intelligence server node 102 may process the predictive outputs data received from the AI/ML module 107 to generate a list of programming parameters that may be converted into control commands (signals) and/or command sequences.

In one embodiment, the EsRi Intelligence server node 102 may acquire sensory data from the sensor array 112 periodically in order to check if the EsRi controller 111 needs to be reprogrammed. In another embodiment, EsRi may continually monitor readings from sensors of the sensor array 112 and may detect a reading that deviates from a previous reading (or from a median reading value) by a margin that exceeds a threshold value pre-set for this particular reading. For example, if a temperature or wind drops by more than 30%, this may cause an upcoming drastic change in electric energy generation conditions. As another non-limiting example, a significant drop in humidity or atmospheric pressure, etc. may also cause critical changes in electric energy generation. Accordingly, once the threshold is met or exceeded by at least one sensor reading (i.e., sensory data), the EsRi Intelligence server node 102 may provide the currently acquired readings to the AI/ML module 107 to generate a list of updated programming parameters based on the current conditions.

While this example describes in detail only one of the EsRi Intelligence server node 102, multiple such nodes may be connected to the network and to the Blockchain 110. It should be understood that the EsRi Intelligence server node 102 may include additional components and that some of the components described herein may be removed and/or modified without departing from a scope of the prediction server node 102 disclosed herein. The EsRi Intelligence server node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the prediction server node 102 may include multiple processors, multiple cores, or the like, without departing from the scope of the EsRi Intelligence server node 102 system.

The EsRi Intelligence server node 102 may also include a non-transitory computer readable medium 212 that may have stored thereon machine-readable instructions executable by the processor 204. Examples of the machine-readable instructions are shown as 214-222 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of computer storage device.

Processor 204 may fetch, decode, and execute the machine-readable instructions 214 to receive sensory data from a sensor array 112 attached to an energy grid 101 coupled to the at least one EsRi controller 111. Processor 204 may fetch, decode, and execute the machine-readable instructions 216 to parse the sensory data to derive a plurality of features. Processor 204 may fetch, decode, and execute the machine-readable instructions 218 to query a local grid database 103 to retrieve local historical electric energy grid-related data collected from the electric energy grid based on current time and date. Processor 204 may fetch, decode, and execute the machine-readable instructions 220 to generate at least one feature vector based on the plurality of features and the historical electric energy grid-related data.

Processor 204 may fetch, decode, and execute the machine-readable instructions 222 to provide the at least one feature vector to the ML module 107 configured to generate a predictive model 108 indicating at least one programming parameter for re-programming of the at least one EsRi controller 111. The permissioned Blockchain 110 may be configured to use one or more smart contracts that manage transactions for multiple participating nodes and for recording the transactions on the ledger 109.

In one embodiment, the EsRi controller 111 may provide multiple analog-to-digital inputs. Therefore, the voltage is actively monitored to ensure the voltage does not exceed a predetermined limit. If that limit is exceeded, the EsRi controller 111 can quickly respond (typically within microseconds) and turn off all outputs until the fault condition is automatically corrected.

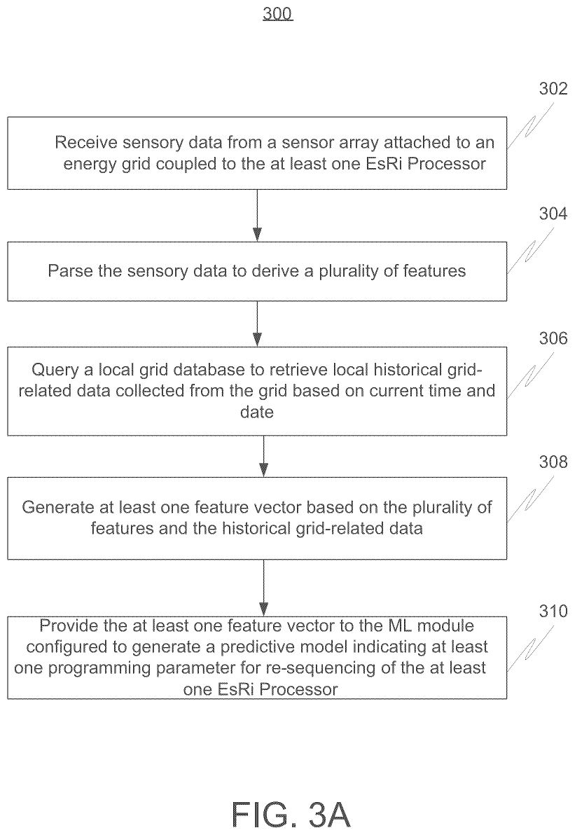

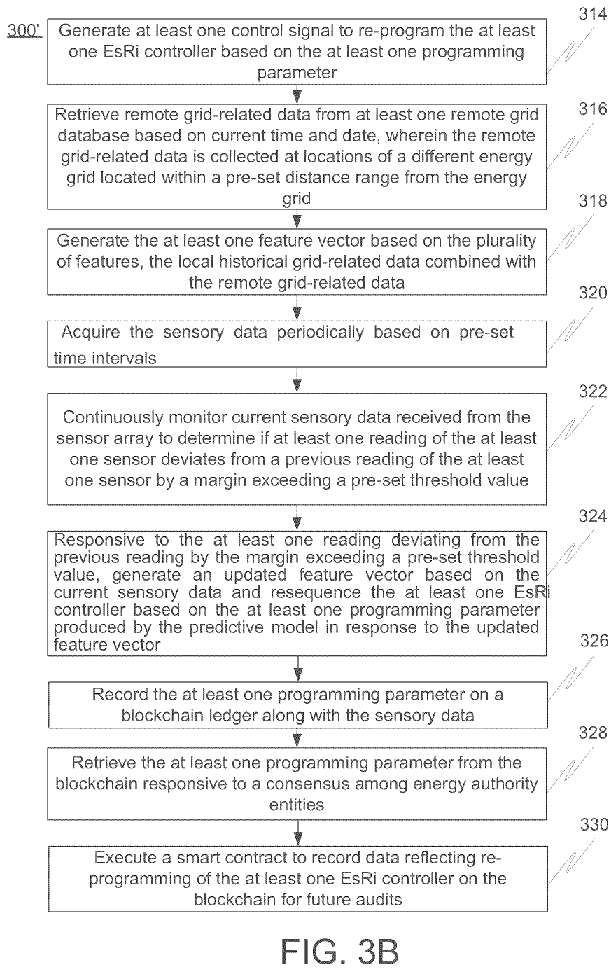

FIG. 3A illustrates a flowchart of a method for an intelligent EsRi system consistent with the present disclosure.

Referring to FIG. 3A, method 300 may include one or more of the steps described below. FIG. 3A illustrates a flow chart of an example method executed by the EsRi Intelligence server node 102 (see FIG. 2). It should be understood that method 300 depicted in FIG. 3A may include additional operations and that some of the operations described therein may be removed and/or modified without departing from the scope of method 300. The description of method 300 is also made with reference to the features depicted in FIG. 2 for purposes of illustration. Particularly, processor 204 of the EsRi Intelligence server node 102 may execute some or all of the operations included in the method 300.

With reference to FIG. 3A, at block 302, processor 204 may receive sensory data from a sensor array attached to an electric energy grid coupled to at least one EsRi controller. At block 304, processor 204 may parse the sensory data to derive a plurality of features. At block 306, processor 204 may query a local electric energy grid database to retrieve local historical electric energy grid-related data collected from the electric energy grid based on current time and date. At block 308, processor 204 may generate at least one feature vector based on the plurality of features and the historical electric energy grid-related data. At block 310, processor 204 may provide at least one feature vector to the ML module configured to generate a predictive model indicating at least one programming parameter for re-programming of the at least one EsRi controller.

FIG. 3B illustrates a further flow chart of a method for the intelligent EsRi system consistent with the present disclosure.

Referring to FIG. 3B, method 300′ may include one or more of the steps described below. FIG. 3B illustrates a flow chart of an example method executed by the EsRi Intelligence server node 102 (see FIG. 2). It should be understood that method 300′ depicted in FIG. 3B may include additional operations and that some of the operations described therein may be removed and/or modified without departing from the scope of method 300′. The description of method 300′ is also made with reference to the features depicted in FIG. 2 for purposes of illustration. Particularly, processor 204 of EsRi Intelligence server node 102 may execute some or all of the operations included in the method 300′.

With reference to FIG. 3B, at block 314, processor 204 may generate at least one control signal to re-program the at least one EsRi controller based on the at least one programming parameter. At block 316, processor 204 may retrieve remote electric energy grid-related data from at least one remote electric energy grid database based on current time and date, wherein the remote electric energy grid-related data is collected at locations of a different electric energy grid located within a pre-set distance range from the electric energy grid. At block 318, processor. 204 may generate at least one feature vector based on the plurality of features, the local historical electric energy grid-related data combined with the remote electric energy grid-related data. At block 320, processor 204 may acquire the sensory data periodically based on pre-set time intervals. At block 322, processor 204 may continuously monitor current sensory data received from the sensor array to determine if at least one reading of the at least one sensor deviates from a previous reading of the at least one sensor by a margin exceeding a pre-set threshold value. At block 324, processor 204 may, being responsive to at least one reading deviating from the previous reading by the margin exceeding a pre-set threshold value, generates an updated feature vector based on the current sensory data and reprogram the at least one EsRi controller based on at least one programming parameter produced by the predictive model in response to the updated feature vector. At block 326, processor 204 may record at least one programming parameter on a Blockchain ledger along with the sensory data. At block 328, processor 204 may retrieve at least one programming parameter from the Blockchain responsive to a consensus among energy authority entities. At block 330, processor 204 may execute a smart contract to record data reflecting re-programming of at least one EsRi controller on the Blockchain for future audits.

In one disclosed embodiment, the programming parameters' model may be generated by the AI/ML module 107 which may use training data sets to improve accuracy of the prediction of the programming parameters for the EsRi controller 111 (FIG. 2). The programming parameters used in training data sets may be stored in a centralized local database (such as one used for storing local electric energy grid-related data 103 depicted in FIG. 1A). In one embodiment, a neural network may be used in the AI/ML module 107 for electric energy grid modeling and re-programming predictions.

In another embodiment, the AI/ML module 107 may use a decentralized storage such as Blockchain 110 (see FIG. 1B) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, peers 113 and 102 (FIG. 1B) may execute a consensus protocol to validate Blockchain storage transactions, group the storage transactions into blocks, and build a hash chain over the blocks. This process forms the ledger by ordering the storage transactions, as is necessary, for consistency. In various embodiments, a permissioned and/or a permissionless Blockchain can be used. In a public or permissionless chain, anyone can participate without a specific identity. Public “Blockchains” can involve assets and use consensus based on various protocols such as Proof of Work (PoW). On the other hand, a permissioned “Blockchain” provides secure interactions among a group of entities which share a common goal such as storing programming parameters for efficient functioning of the traffic light, but which do not fully trust one another.

This application utilizes a permissioned (private) Blockchain that operates arbitrary, programmable logic, tailored to a decentralized storage scheme and referred to as “smart contracts” or “chaincodes.” In some cases, specialized chaincodes may exist for management functions and parameters which are referred to as system chaincodes. The application can further utilize smart contracts that are trusted distributed applications which leverage tamper-proof properties of the Blockchain database and an underlying agreement between nodes, which is referred to as an endorsement or endorsement policy. Blockchain transactions associated with this application can be “endorsed” before being committed to the Blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

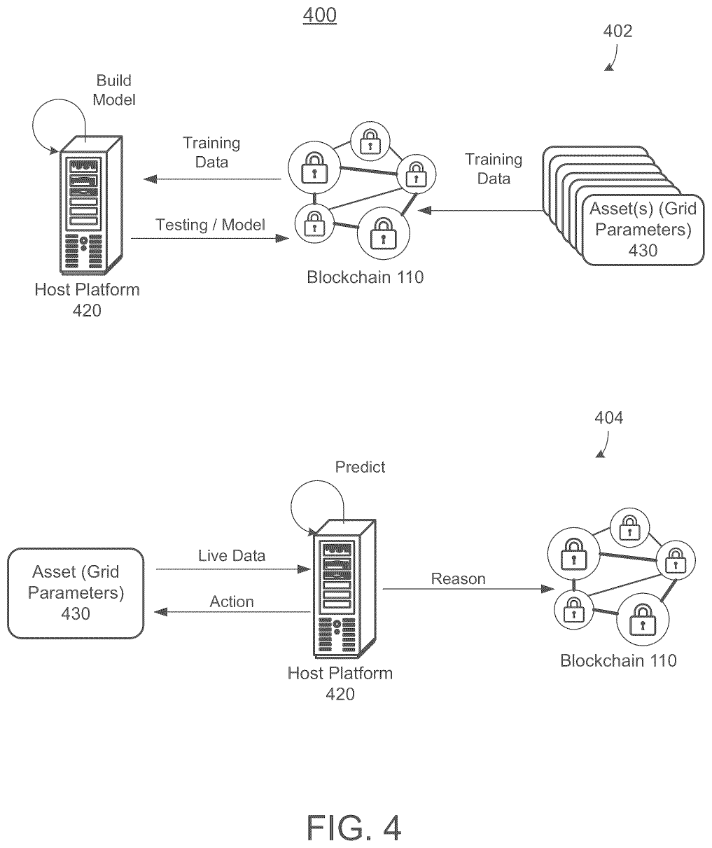

In the example depicted in FIG. 4, a host platform 420 (such as an EsRi Intelligence server node 102) builds and deploys a machine learning (ML) model for predictive monitoring of assets 430. Here, the host platform 420 may be a cloud platform, an industrial server, a web server, a personal computer, a user device, and or like data storage mechanisms. Assets 430 can represent EsRi controller programming parameters. The Blockchain 110 can be used to significantly improve both training process 402 of the machine learning model and the programming parameters' predictive process 405 based on a trained machine learning (ML) model. For example, in 402, rather than requiring a data scientist/engineer or other user to collect the data, historical data (heuristics—i.e., electric energy grid-related data) may be stored by the assets 430 themselves (or through an intermediary, not shown) on the Blockchain 110.

This can significantly reduce the collection time needed by the host platform 420 when performing predictive model training. For example, using smart contracts, data can be directly and reliably transferred straight from its place of origin (e.g., from the sensor array) to the Blockchain 110. By using the Blockchain 110 to ensure the security and ownership of the collected data, smart contracts may directly send the data from the assets to the entities that use the data for building a machine learning (ML) model. This allows for sharing of data among the assets 430. The collected data may be stored in the AI/ML module 110 based on a consensus mechanism. The consensus mechanism pulls in (permissioned nodes) to ensure that the data being recorded is verified and accurate. The data recorded is time-stamped, cryptographically signed, and immutable. It is therefore auditable, transparent, and secure.

Furthermore, training of the machine learning model on the collected data may take rounds of refinement and testing by the host platform 420. Each round may be based on additional data or data that was not previously considered to help expand the knowledge of the machine learning (ML) model. In 402, the different training and testing steps (and the data associated therewith) may be stored on the Blockchain 110 by the host platform 420. Each refinement of the machine learning (ML) model (e.g., changes in variables, weights, etc.) may be stored on Blockchain 110. This provides verifiable proof of how the model was trained and what data was used to train the model. Furthermore, when the host platform 420 has finally achieved a trained model, the resulting model itself may be stored on Blockchain 110.

After the model has been trained, it may be deployed to a live environment where it can make electric energy grid risk and functionality predictions/decisions based on the execution of the final trained machine learning model using the programming parameters. In this example, data fed back from the asset 430 may be input into the machine learning model and may be used to make event predictions such as most optimal programming parameters for re-programming the EsRi controller of the electric energy grid. Determinations made by the execution of the machine learning model (e.g., programming parameters, etc.) at the host platform 420 may be stored on the Blockchain 110 to provide auditable/verifiable proof. As one non-limiting example, the machine learning (ML) model may predict a future change of a part of the asset 430 (the programming parameters). The data behind this decision may be stored by the host platform 420 on Blockchain 110.

As discussed above, in one embodiment, the features and/or the actions described and/or depicted herein can occur on or with respect Blockchain 110.

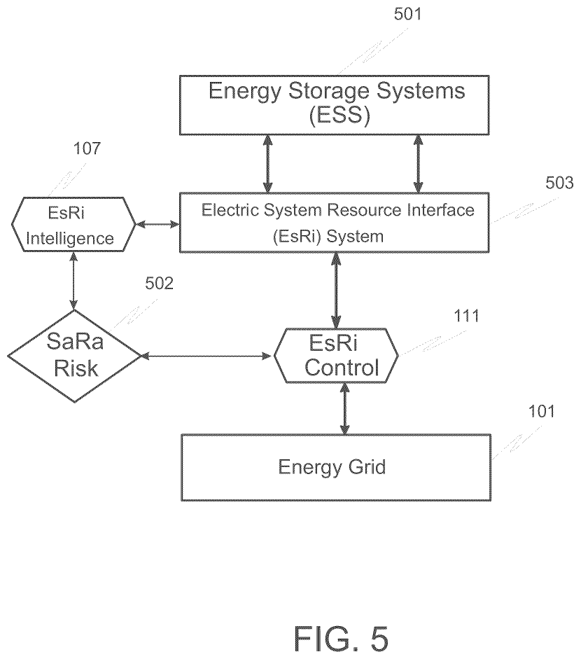

FIG. 5 illustrates an architecture of the EsRi system consistent with the present disclosure.

As discussed above, the Electronic Safety Response Interface (EsRi) system 503 for a multi-modal electric energy generation and/or energy storage facility is a solution that facilitates the electric energy grid of the future. The disclosed EsRi system enables a electric energy generation and/or storage facility 501 to deliver a wide range of applications, including direct delivery of electric power to the electric energy grid as well as load-shifting, frequency regulation and other ancillary services as well as the ability to provide long-duration storage with a consistent interface with the electric energy grid 101.

The disclosed EsRi system 503 simplifies the process of multi-modal hybrid and/or bi-located electric generation and storage design by making the interconnection from the ESS 501 side more standardized and easier to model. Improving the interconnection process and subsequent analysis, the electric energy storage system component of facility systems 501 can serve as bulk storage for intermittent electric generation power plants. As a transmission asset, the electric generation and/or storage system 501 may function as an electric energy grid 101 reliability tool to smooth out unexpected events and shift electric load. Each facility system 501 has a specific set of performance parameters that demonstrates different electric characteristics. The EsRi system 503 smooths these characteristics to protect the electric energy grid 101, protect the facility systems 501, and to provide the interface for scheduling and dispatch software that optimizes the facility systems 501 response while minimizing the impact of perturbations on the electric energy grid 101. Combined, these EsRi system 503 features make it easier to model the interconnection interface thereby reducing analysis time and improving reliability.

The disclosed EsRi system 503 is a three-phase alternating current (AC) protection system designed to assure that all the electricity generation and/or storage modalities in an EsRi protected facility will respond in an acceptable and uniform manner to electric energy grid perturbances thus, making electric energy grid planning and operations consistently predictable. The disclosed architecture includes EsRi Intelligence (server) 107 and risk decision module 502 connected to the EsRi controller unit 111 discussed in more detail above.

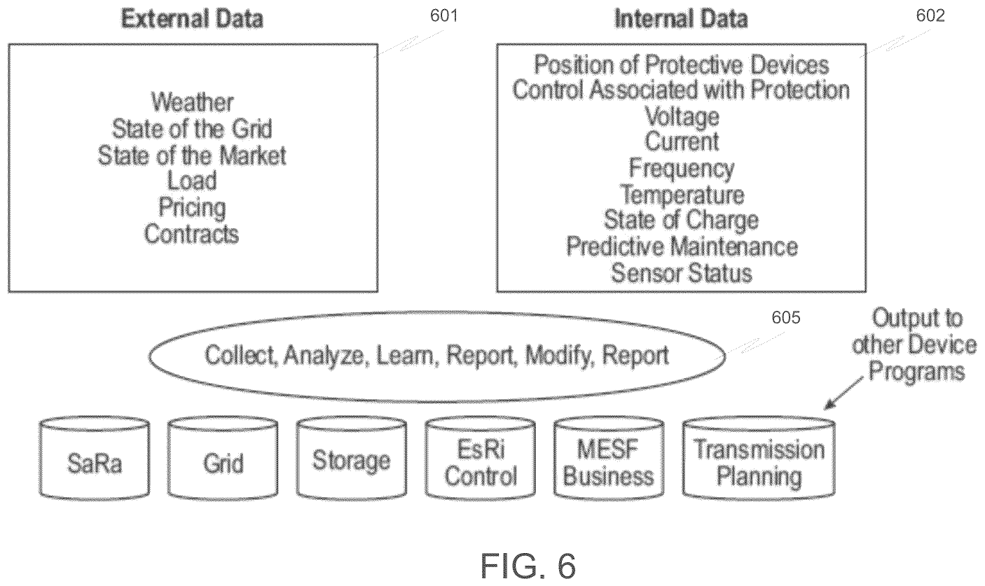

FIG. 6 illustrates the type of data inputs that may be deployed by the EsRi system consistent with the present disclosure.

The external data inputs 601 are: weather, state of the electric energy grid, state of the market, load, pricing and contracts.

The internal data inputs 602 are: position of protective devices, control associated with protection, voltage, current, frequency, temperature, power generation, state of charge, predictive maintenance and sensor status among other inputs. The system functionality is listed in 605 and the data may be output to a variety of the devices shown below the 605.

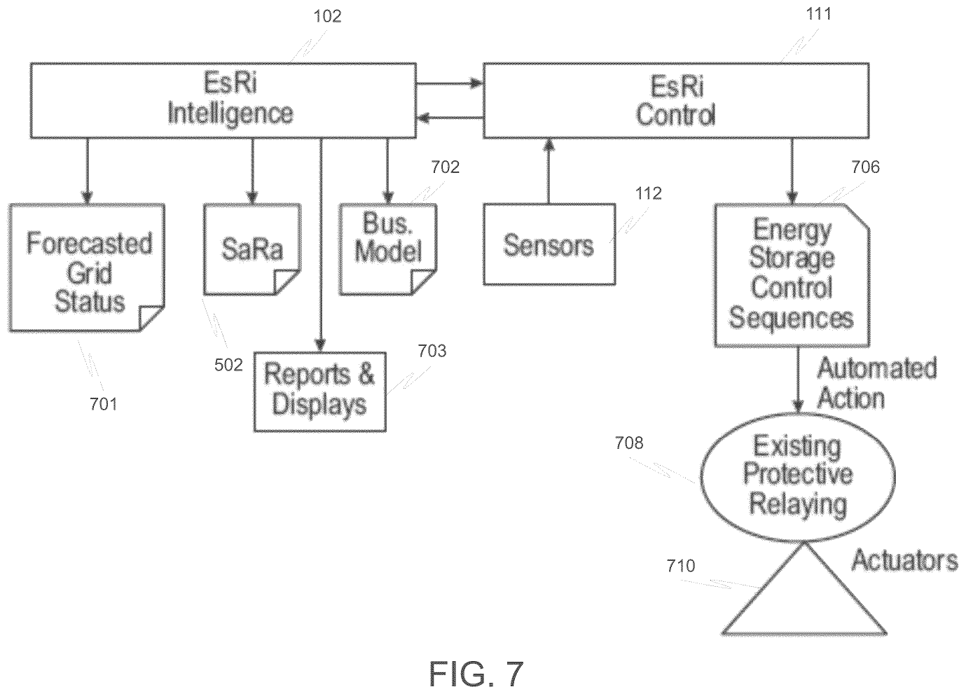

FIG. 7 illustrates a further arrangement of elements of the intelligent EsRi system including EsRi controller consistent with the present disclosure.

Referring to FIG. 7, the example architecture includes the EsRi Intelligence server node 102 connected. The EsRi Intelligence server node 102 may receive sensory data from an array of sensors 112. Note that the array of sensors 112 may be connected to the EsRi controller 111.

The EsRi Intelligence server node 102 may generate predictive model(s) based configured to predict programming parameters for automatically programming the EsRi controller 111. The programming parameters may be provided to a programmable EsRi controller 111 operatively coupled to the electric energy grid (not shown).

The EsRi Intelligence server node 102 is implemented as a machine-learning (ML) system configured to predict (i.e., forecast) electric energy grid status 701, a risk assessment 502 from an electric generation and/or storage facility and to create outputs in a form of control sequences 706 that keep the generation and/or energy storage units in operation while providing reliable power during multiple electric energy grid 101 and facility malfunctions and electric perturbations. The control sequences 706 may pass through protective relaying 708 on to actuators 710. The EsRi Intelligence server node 102 may also produce business model outputs 702 and may provide reporting data 703.

The EsRi controller 111 may be configured to augment and supplement protective relaying system 708 typically connected to the electric energy grid to maintain uninterrupted power flow under multiple risk scenarios and equipment failures without a human intervention. The EsRi controller 111 may be configured to overlay and expand on the standard protective relaying control systems to provide a reliable electric path to the electric energy grid during battery and/or other storage failures. The disclosed EsRi controller 111 may rely on expanded smart sensors 112 to provide rapid information to the control system to maintain reliable power flow to the electric energy grid under various events by segmenting the protective relaying responses commensurate with predicted risk.

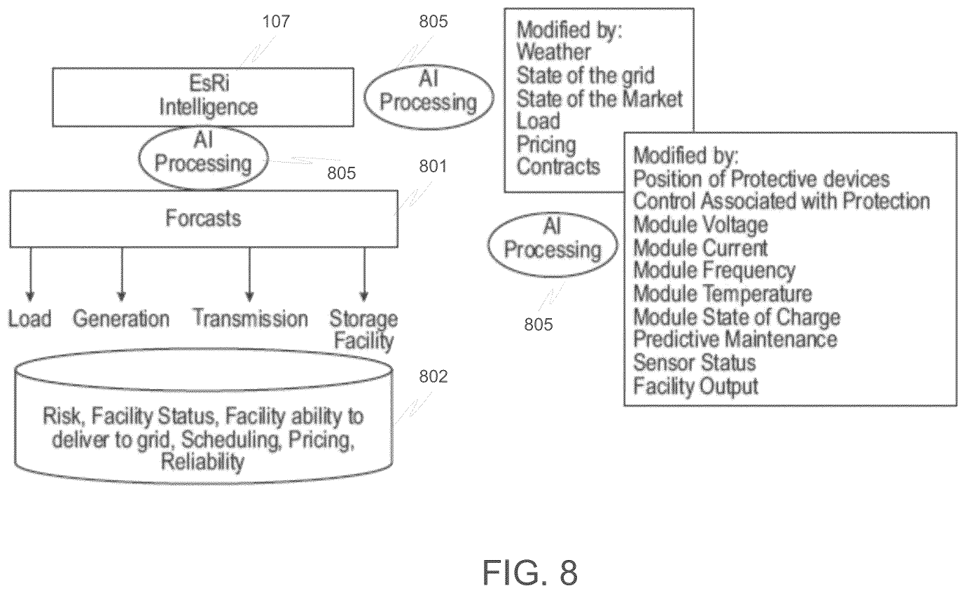

FIG. 8 illustrates an example of AI processing within the intelligent EsRi system consistent with the present disclosure.

As discussed above, the EsRi Intelligence server node 102 may implement AI processing 805 for forecasts 801 of electric load, generation, transmission and/or storage facility. Further predicted data may include data points 802. As discussed above with respect to FIG. 6, the EsRi Intelligence server node 102 may ingest data related to weather, state of the electric energy grid, state of the market, load, pricing and contracts. The EsRi Intelligence server node 102 may apply AI processing 805 to this data through to predict data related to: position of protective devices, control associated with protection, module generation, module voltage, module current, module frequency, module temperature, module state of charge, predictive maintenance, sensor status and facility output.

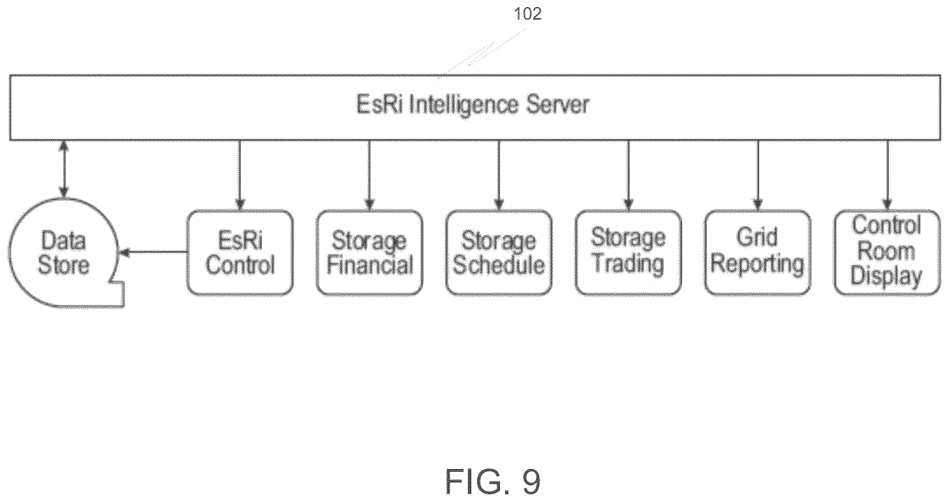

FIG. 9 illustrates examples of functionality of an EsRi Intelligence server consistent with the present disclosure.

The functionality of the EsRi Intelligence server 102 may include controlling the data store through the controller, store financial data, store schedule data, store storage trading data, implement electric energy grid reporting via control room display.

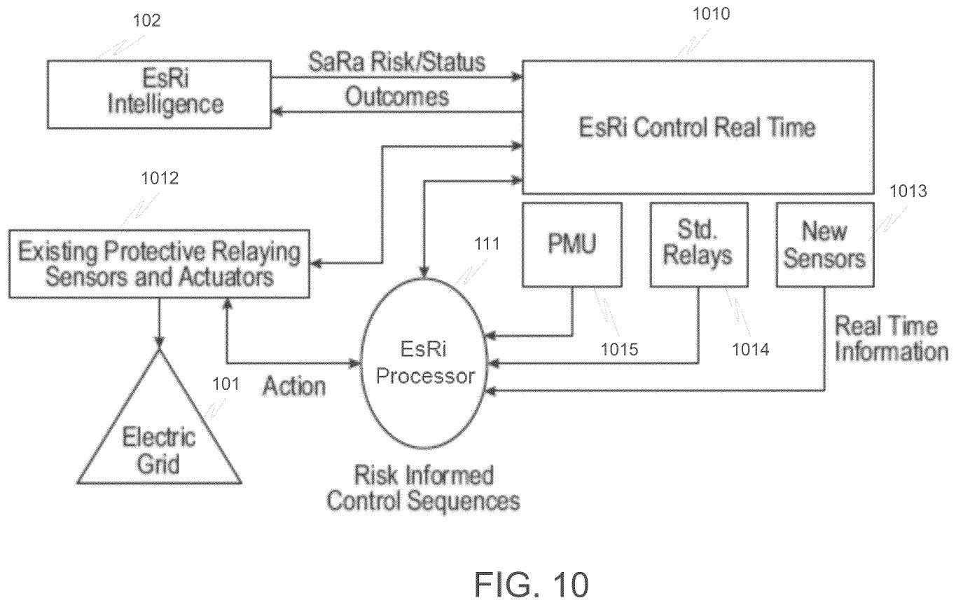

FIG. 10 illustrates generation of risk status inputs of the EsRi controller consistent with the present disclosure.

As discussed above, the EsRi controller 111 uses SaRa risk levels to preprogram hardware and software to protect both the electric energy grid 101 and generation and/or storage facilities. The EsRi controller 111 is configured to be modeled as a standardized interconnection. The EsRi Controller application, using protective relaying principles, absorbs and smooths perturbations caused by the different electric generation and/or storage inverter systems.

EsRi Control real time module 1010 receives SaRa risk/status prediction(s) data and provides this data to the EsRi controller 111 coupled to sensors 1013, standard relays 1014 and phasor management unit (PMU) 1015. The EsRi controller 111 produces risk informed control sequences that are passed on to the electric energy grid 101 via protective relays, sensors and actuators 1012 shown in other FIGS.

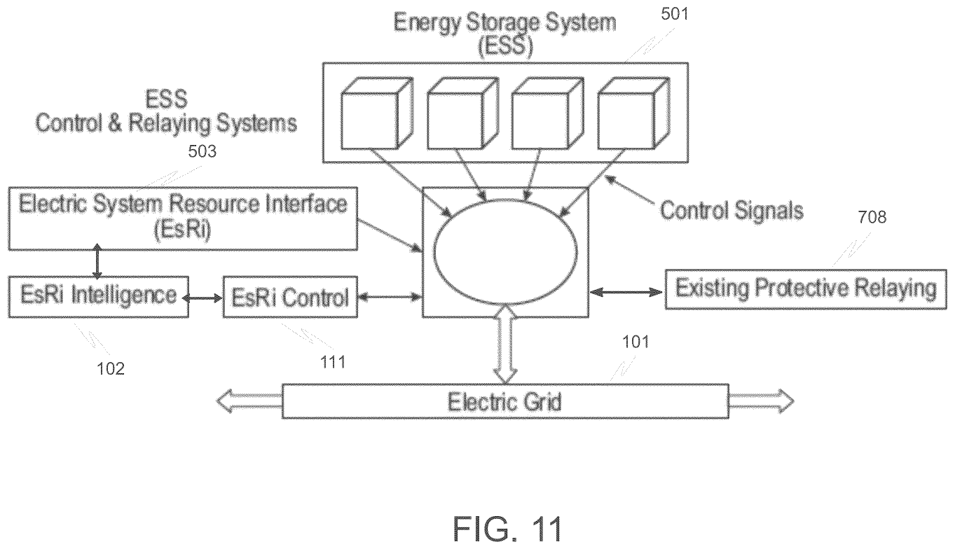

FIG. 11 illustrates an example of an electric energy storage system (ESS) employing the EsRi system consistent with the present disclosure.

The ESS 501 is connected to the electric energy grid 101. The EsRi system 503 is coupled to the EsRi Intelligence server 102 configured to generate control sequences discussed above that are passed through the protective relays 708 to the electric energy grid 101. The control signals from the ESS 501 may be received into EsRi controller 111 and processed by the EsRi Intelligence server 102.

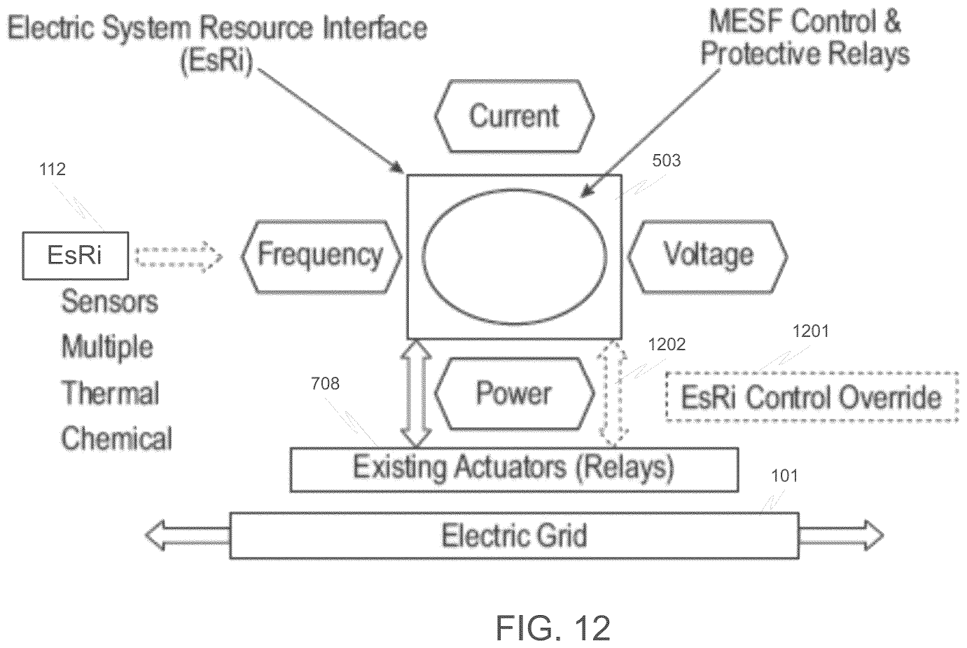

FIG. 12 illustrates exemplary implementation of the EsRi system with multi-modal renewable energy generation and a hybrid, bi-located or standalone energy storage facility control and protective relays consistent with the present disclosure.

The EsRi sensors 112 may provide a variety of data including chemical and thermal readings into the EsRi system 503. The EsRi sensors 112 may provide readings of frequency, voltage, current from the facility control and protective relays. The power input/outputs to and from the electric energy grid 101 over existing actuator relays 708 may be measured. If the readings exceed certain pre-set thresholds, the EsRi control override 1201 occurs to prevent excessive power inputs/outputs to and from the electric energy grid 101.

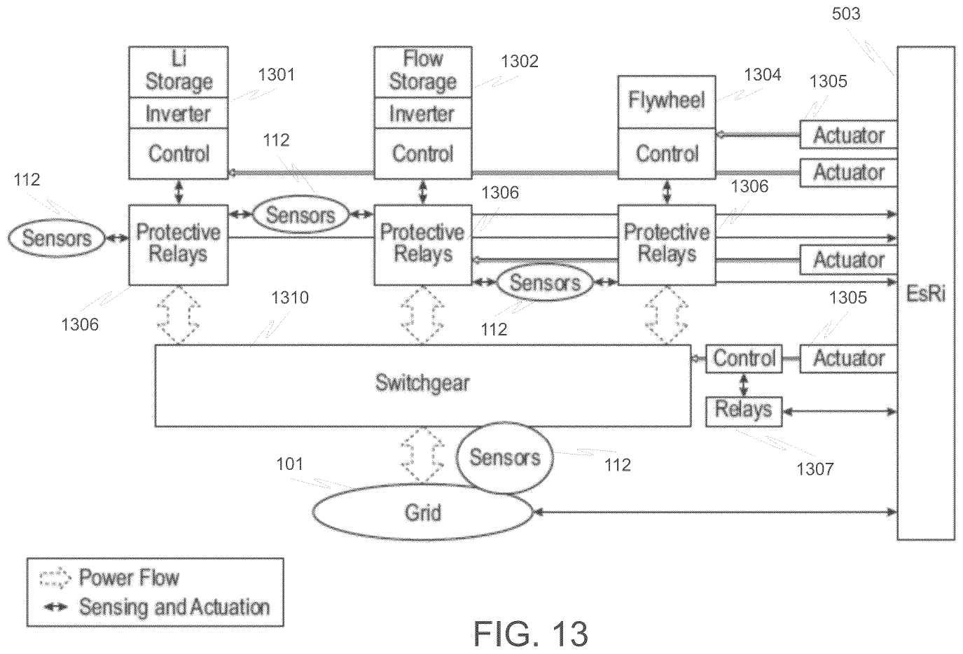

FIG. 13 illustrates exemplary implementation of the EsRi system actuator control flow consistent with the present disclosure.

This example illustrates and embodiment for management of the electric energy grid 101 using generation and/or storage switchgear 1310. EsRi Control governs both the control and the protective relaying systems of the generation and/or electric storage modules and the facility switchgear 1310. Examples of electric energy storage modes may be Li storage 1301, flow storage 1302, flywheel 1304 communicating with the EsRi system over actuators 1305. The EsRi Control provides several unique functions over and above standard protective relaying:
Additional sensors 112 for faster response and for different parameters to maintain electric energy grid and electric generation and/or storage system operability and security;
Continual comparative analysis of operability between storage functions, facility switchgear 1310 and the electric energy grid 101, always looking for operable pathways to deliver capacity and energy;
Preprogrammed control sequences based on SaRa risk assessment provided by EsRi Intelligence;
Protective system collaboration with existing protective relaying 1306 to maintain electric circuit integrity while isolating failures under varying risk scenarios; and

### Operator Reporting and Communication.

In this example, the power flow exists between the electric energy grid 101 and the facility switchgear 1310 and between the facility switchgear 1310 and the protective relays 1306.

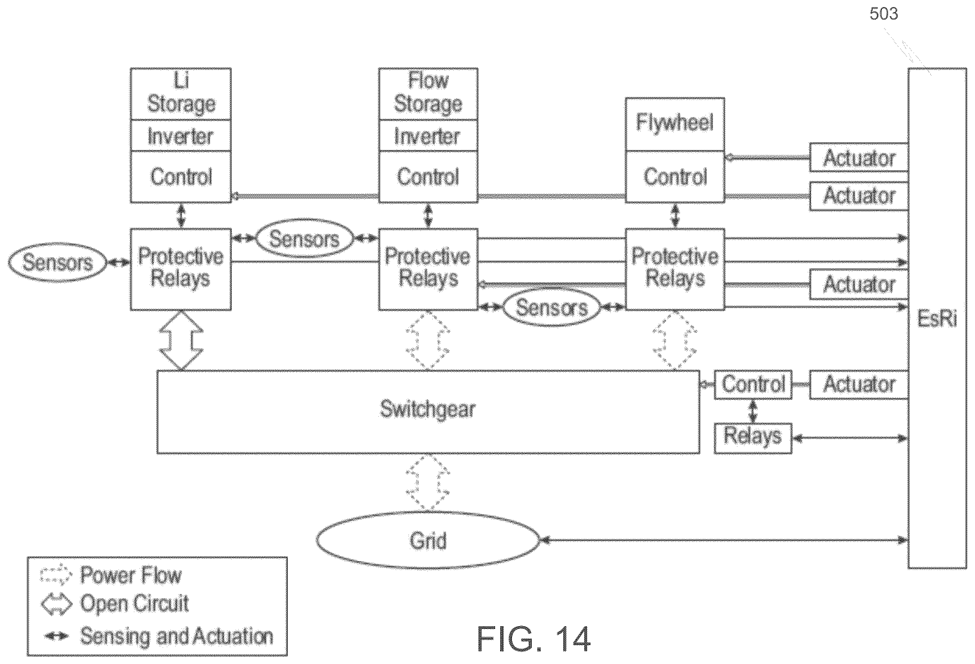

FIG. 14 illustrates exemplary implementation of the EsRi system Control Flow for Lithium Fault consistent with the present disclosure.

The exemplary system and elements are consistent with the system depicted in FIG. 13.

The EsRi system 503 may process Lithium Fault as follows:
Lithium-Ion Battery energy storage system (local BESS control) detects abnormality-protective relays isolate Lithium-Ion battery module flow path only;
EsRi Control detects and isolates, pulls down SaRa risk status, checks system status and initiates pre-programmed responses;
EsRi Control checks flywheel, flow battery systems and switchgear for operability (in the green), compares to pre-programmed response and prevents switchgear breaker to the electric energy grid from opening as flywheels initially pick up the load and LI breaker open isolating fault;
EsRi Control closes breakers to flow batteries allowing flow battery to supply the load;
No interruption in electric supply occurs as long as EsRi Control shows other systems in the green.

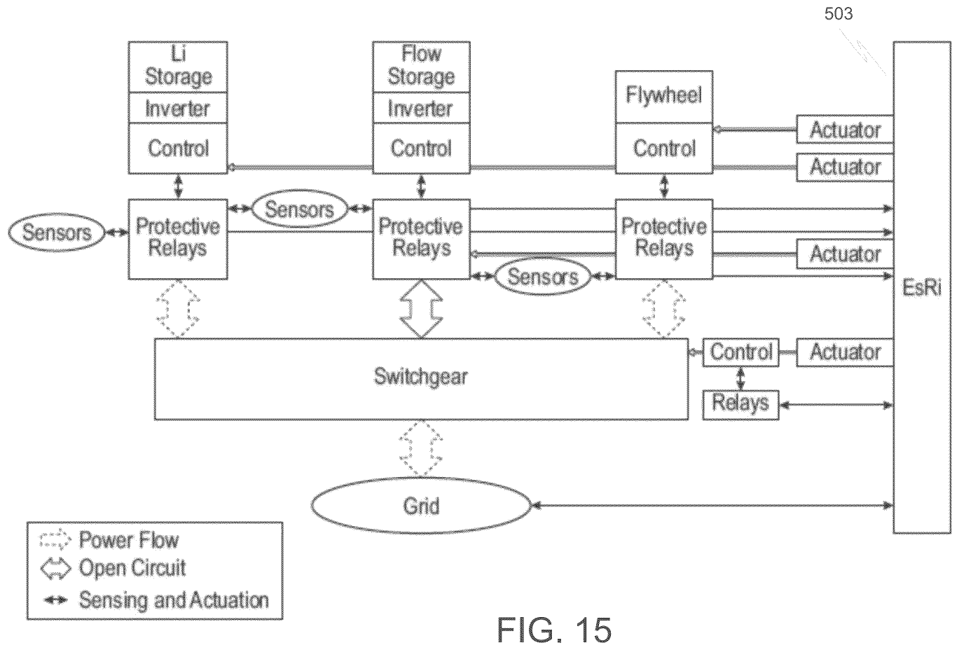

FIG. 15 illustrates exemplary implementation of the EsRi system Control Flow for Flow Battery consistent with the present disclosure.

The exemplary system and elements are consistent with the system depicted in FIG. 13.

The EsRi system 503 may process Flow Battery as follows:
Flow Battery system detects abnormality-protective relays isolate Flow battery path only;
EsRi Control detects isolation and checks flywheel, Lithium-Ion battery systems and switchgear for operability (in the green), prevents breaker to the electric energy grid from opening as flywheels pick up the load;
EsRi Control closes breakers to Lithium-Ion (LI) batteries allowing LI battery to supply the load; and
No interruption in supply occurs as long as EsRi Control shows other systems in the green.

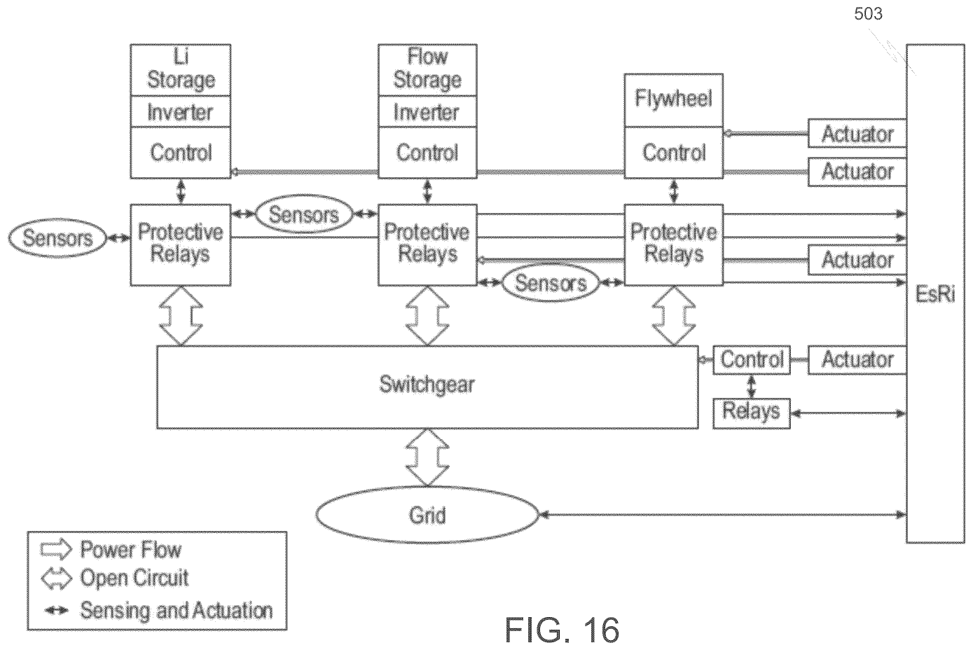

FIG. 16 illustrates exemplary implementation of the EsRi system Control Flow for Switchgear Fault consistent with the present disclosure.

The exemplary system and elements are consistent with the system depicted in FIG. 13.

The EsRi system 503 may process switchgear fault as follows:
Protective relaying system detects abnormality in grid or switchgear and isolates electric energy grid and the electric generation and/or storage facility from switchgear fault;
EsRi Control detects isolation and allows normal protective relaying to operate. No need for SaRa risk or comparative in the green checks; and
EsRi Control detects isolation and allows normal protective relaying to operate. No need for SaRa risk or comparative in the green checks; and
The above embodiments of the present disclosure may be implemented in hardware, in a computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

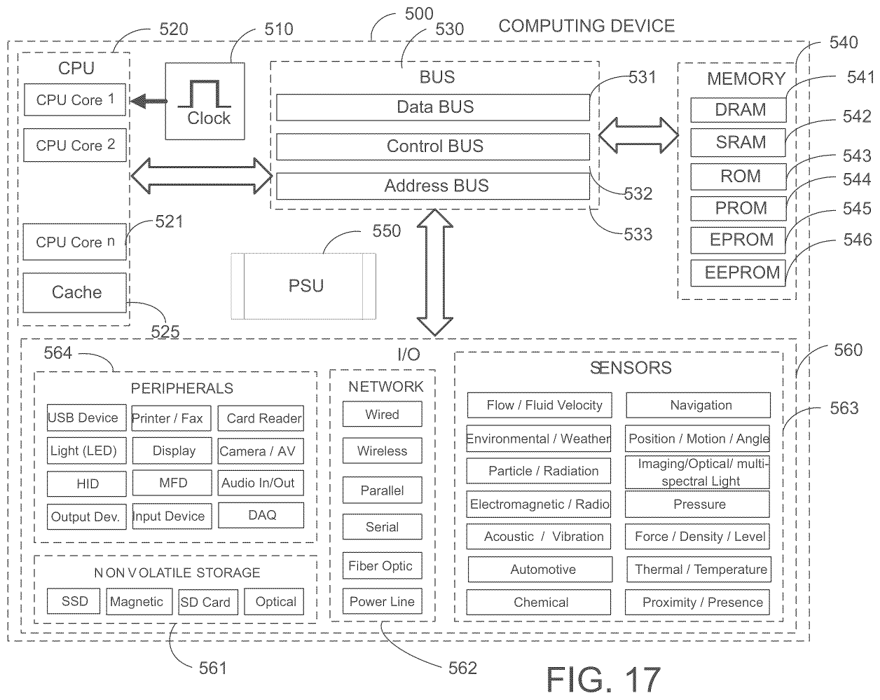

An exemplary data storage medium may be coupled to the processor such that the processor may read information from, and write information to, the data storage medium. In the alternative, the data storage medium may be integral to the processor. The processor and the data storage medium may reside in an application specific integrated circuit (“ASIC”). In the alternative embodiment, the processor and the storage medium may reside as discrete components. For example, FIG. 17 illustrates an example computing device (e.g., an EsRi Intelligence server node 102) 500, which may represent, or be integrated in, any of the above-described components, etc.

FIG. 17 illustrates a block diagram of a system including computing device 500. The computing device 500 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS500/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device.

The EsRi Intelligence server node 102 (see FIG. 2) may be hosted on a centralized server or on a cloud computing service. Although method 300 has been described to be performed by the EsRi Intelligence server node 102 implemented on a computing device 500, it should be understood that, in some embodiments, different operations may be performed by a plurality of the computing devices 500 in operative communication at least one network.

Embodiments of the present disclosure may comprise a computing device having a central processing unit (CPU) 520, a bus 530, a memory unit 550, a power supply unit (PSU) 550, and one or more Input/Output (I/O) units. The CPU 520 coupled to the memory unit 550 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 520, the bus 530, the memory unit 550, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 550 may be implemented with computing device 500 or any of other computing devices 500, in combination with computing device 500. The aforementioned system, device, and components are examples and other systems, devices, and components may comprise the aforementioned CPU 520, the bus 530, the memory unit 550, consistent with embodiments of the disclosure.

At least one computing device 500 may be embodied as any of the computing elements illustrated in all of the attached figures, including the design server node 102 (FIG. 2). A computing device 500 does not need to be electronic, nor even have a CPU 520, nor bus 530, nor memory unit 550. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 17, a system consistent with an embodiment of the disclosure may include a computing device, such as computing device 500. In a basic configuration, computing device 500 may include at least one clock module 510, at least one CPU 520, at least one bus 530, and at least one memory unit 550, at least one PSU 550, and at least one I/O 560 module, wherein I/O module may be comprised of, but not limited to a non-volatile storage sub-module 561, a communication sub-module 562, a sensors sub-module 563, and a peripherals sub-module 565.

A system consistent with an embodiment of the disclosure the computing device 500 may include the clock module 510 may be known to a person having ordinary skill in the art as a clock generator, which produces clock signals. A clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively one wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 550 or input/output 560). Some embodiments of clock 510 may include dynamic frequency change, where the time between clock edges can vary widely from one edge to the next and back again.

A system consistent with an embodiment of the disclosure the computing device 500 may include CPU unit 520 comprising at least one CPU Core 521. A plurality of CPU cores 521 may comprise identical CPU cores 521, such as, but not limited to; homogeneous multi-core systems. It is also possible for the plurality of CPU cores 521 to comprise different CPU cores 521, such as, but not limited to, heterogeneous multi-core systems, big. LITTLE systems and some AMD accelerated processing units (APU). CPU unit 520 reads and executes program instructions which may be used across many application domains, for example, but not limited to, general purpose computing, embedded computing, network computing, digital signal processing (DSP), and graphics processing (GPU). CPU unit 520 may run multiple instructions on separate CPU cores 521 at the same time. CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, clock 510, CPU 520, bus 530, memory 550, and I/O 560.

CPU unit 520 may contain cache 522 such as, but not limited to, a level 1 cache, level 2 cache, level 3 cache, or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to, a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus;
Control bus 532;
Address bus 533;
System Management Bus (SMBus);
Front-Side-Bus (FSB);
External Bus Interface (EBI);
Local bus;
Expansion bus;
Lightning bus;
Lightning bus;
Camera Link;
ExpressCard;

Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.;
Small Computer System Interface (SCSI)/Serial Attached SCSI (SAS);
HyperTransport;
InfiniBand;
RapidIO;
Mobile Industry Processor Interface (MIPI);
Coherent Processor Interface (CAPI);
Plug-n-play;
1-Wire;

Peripheral Component Interconnect (PCI), including embodiments such as, but not limited to, Accelerated Graphics Port (AGP), Peripheral Component Interconnect extended (PCI-X), Peripheral Component Interconnect Express (PCIe) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS);

Industry Standard Architecture (ISA), including embodiments such as, but not limited to Extended ISA (EISA), PC/XT-bus/PC/AT-bus/PC/105 bus (e.g., PC/105-Plus, PCI/105-Express, PCI/105, and PCI-105), and Low Pin Count (LPC);

### Music Instrument Digital Interface (MIDI); and

Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1395 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, know to the person having ordinary skill in the art as primary data storage or memory 550. The memory 550 operates at high speed, distinguishing it from the non-volatile data storage sub-module 561, which may be referred to as secondary or tertiary data storage, which provides slow-to-access information but offers higher capacities at lower cost. The contents contained in memory 550, may be transferred to secondary storage via techniques such as, but not limited to, virtual memory and swap. The memory 550 may be associated with addressable semiconductor memory, such as integrated circuits consisting of silicon-based transistors, used for example as primary storage but also for other purposes in the computing device 500. The memory 550 may comprise a plurality of embodiments, such as, but not limited to volatile data memory, non-volatile data memory, and semi-volatile data memory. It should be understood by a person having ordinary skill in the art that the ensuing are non-limiting examples of the aforementioned memory:

Volatile data memory which requires power to maintain stored information, for example, but not limited to, Dynamic Random-Access Memory (DRAM) 551, Static Random-Access Memory (SRAM) 552, CPU Cache memory 525, Advanced Random-Access Memory (A-RAM), and other types of primary data storage such as Random-Access Memory (RAM);

Non-volatile data memory which can retain stored information even after power is removed, for example, but not limited to, Read-Only Memory (ROM) 553, Programmable ROM (PROM) 555, Erasable PROM (EPROM) 555, Electrically Erasable PROM (EEPROM) 556 (e.g., flash memory and. Electrically Alterable. PROM [EAPROM]), Mask ROM (MROM), One Time Programable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory; and

Semi-volatile data memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).

Consistent with the embodiments of the present disclosure, the aforementioned computing device 500 may employ the non-volatile data storage sub-module 561, which may be referred to by a person having ordinary skill in the art as one of secondary data storage, external memory, tertiary data storage, off-line data storage, and auxiliary data storage. The non-volatile data storage sub-module 561 may not be accessed directly by the CPU 520 without using intermediate area in the memory 550. The non-volatile data storage sub-module 561 does not lose data when power is removed and may be two orders of magnitude less costly than data storage used in memory module, at the expense of speed and latency. The non-volatile data storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO);
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor;
Magnetic storage such as, but not limited to, Hard Disk Drive (HDD), tape drive, carousel memory, and Card Random-Access Memory (CRAM);
Phase-change memory;
Holographic data storage such as Holographic Versatile Disk (HVD);
Molecular Memory; and
Deoxyribonucleic Acid (DNA) digital data storage.

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to, personal computers, phones, servers, drones, and networking devices such as, but not limited to, hubs, switches, routers, modems, and firewalls.

Two nodes can be said to be networked together when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and data storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802; ethernet, Wireless LAN (WLAN/Wi-Fi), Internet Protocol (IP) suite (e.g., TCP/IP, UDP, Internet Protocol version 5 [IPv5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand;
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,5G (such as WiMax and LTE), and 5G (short and long wavelength);
Parallel communications, such as, but not limited to, LPT ports;
Serial communications, such as, but not limited to, RS-232 and USB;

Fiber Optic communications, such as, but not limited to, Single-mode optical fiber (SMF) and Multi-mode optical fiber (MMF); and

Power Line and wireless communications.

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563. may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors);
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor;
Acoustic, sound and vibration sensors, such as, but not limited to, microphone, lace sensor (guitar pickup), seismometer, sound locator, geophone, and hydrophone;
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector;
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge;
Flow and fluid velocity sensors, such as, but not limited to, air flow meter, anemometer, flow sensor, gas meter, mass flow sensor, and water meter;
Ionizing radiation and particle sensors, such as, but not limited to, cloud chamber, Geiger counter, Geiger-Muller tube, ionization chamber, neutron detection, proportional counter, scintillation counter, semiconductor detector, and thermos-luminescent dosimeter;
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor;
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver;
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver;
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge;
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer;
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple; and

Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 565 comprises ancillary devices used to put information into and get information out of the computing device 500. There are three categories of devices comprising the peripheral sub-module 565, which exist based on their relationship with the computing device 500, input devices, output devices, and input/output devices. Input devices send at least one of the data and instructions to the computing device 500. Input devices can be categorized based on, but not limited to:
Modality of input, such as, but not limited to, mechanical motion, audio, visual, and tactile;
Whether the input is discrete, such as but not limited to, pressing a key, or continuous such as, but not limited to position of a mouse; and
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices perform both input and output functions. It should be understood by a person having ordinary skill in the art that the ensuing are non-limiting embodiments of the aforementioned peripheral sub-module 565:
Input Devices;

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD);

High degree of freedom devices, that require up to six degrees of freedom such as, but not limited to, camera gimbals, Cave Automatic Virtual Environment (CAVE), and virtual reality systems;

Video Input devices are used to digitize images or video from the outside world into the computing device 500 wherein the information can be stored in a multitude of formats depending on the user's requirement (Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner);

Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. (Examples of types of audio input devices include, but not limited to microphone, Musical Instrumental Digital Interface (MIDI) devices such as, but not limited to a keyboard, and headset); and

Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

### Output Devices May Further Comprise, but not be Limited to:

Display devices, which convert electrical information into visual form, including, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal);

Printers, such as, but not limited to, inkjet printers, laser printers, 3D printers, solid ink printers and plotters;

Audio and Video (AV) devices, such as, but not limited to, speakers, headphones, amplifiers and lights, which include lamps, strobes, DJ lighting, stage lighting, architectural lighting, special effect lighting, and lasers; and

Other devices such as Digital to Analog Converter (DAC).

Input/Output Devices may further comprise, but not be limited to, touchscreens, networking devices (e.g., devices disclosed in network 562 sub-module), data storage device (non-volatile storage 561), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

In so far as this Detailed Description and the accompanying drawings disclose any additional subject matter that is not within the scope of the claims below, the disclosures are not dedicated to the public and the right to file one or more applications to claims such additional disclosures is reserved.

I (we) claim:

1. The invention and subject of this disclosure is an Electronic Safety Response Interface (EsRi) system comprised of multiple processors and software that manages electric energy flow in real time to the electric energy grid under both routine and abnormal conditions using risk informed pre-programmed controllers to operate existing controls that manage a reliable electric flow between the electric energy grid and attached energy storage systems. The EsRi interface includes EsRi Intelligence and EsRi Control at the interconnection between the electric energy grid and the generation and energy storge facilities as described above and summarized below.
An EsRi Intelligence processor using multiple data sources (for, example, weather existing electric energy grid equipment configurations, electric energy use (load) contracts, and other data) processed through the EsRi artificial intelligence (AI) to develop risk profiles of the electric energy grid and attached generation and/or storage systems then informing the networked controller processors to operate the safety (protective relaying) controls through pre-programmed (hard-wired) sequences informed (directed) by the intelligence processor outputs using signal(s) from SaRa, the EsRi predictive risk assessment module in real time.
Using SaRa to provide the risk profile signal to the EsRi Control processor in real time allows the selection of the appropriate control sequence. The AI predictive risk profile provided by the EsRi Intelligence server node through the SaRa risk system to the EsRi controller governs which control sequence the controller will use to respond to electric energy grid and/or attached electric generation and/or storage system failures. The sequence selection will change in real time for each state of the electric energy grid provided by the EsRi Intelligence processer through the SaRa risk assessment system.
An EsRi controller processor is preloaded with control sequences that correspond to the state of the electric energy grid and attached electric generation and/or storage systems as represented by the SaRa risk profile. This allows the safety systems in real time to manage a reliable electric energy flow to the electric energy grid during different types of system failures. The EsRi Control sequence both overrides and uses the existing safety controls in a pre-established manner.
Additionally, the EsRi system provides, data storage, data logging, audit capability, alarm and other operational functions that will enhance the machine learning AI accuracy, human operator awareness, and system reliability of an EsRi Intelligence server node connected to at least one EsRi controller over a network; a memory on which are stored machine-readable instructions that when executed by the processor, cause the processor to:
a. receive sensory data from a sensor array attached to the electric energy grid coupled to the at least one EsRi controller;
b. parse the sensory data to derive a plurality of features;
c. query a local electric energy grid database to retrieve local historical electric energy grid-related data collected from the electric energy grid in real time;
d. generate at least one feature vector based on the plurality of features and the historical electric energy grid-related data; and
e. provide at least one feature vector to the ML module configured to generate a predictive model indicating at least one programming parameter for re-sequencing of the at least one EsRi controller (actuating electric energy grid protective relaying).

2. The system of claim 1, wherein the instructions (for example, for building the predictive failure model) further cause the EsRi Intelligence server node to generate at least one risk signal to the SaRa system to transmit to the EsRi Control system selecting the appropriate control sequence for the level of electric energy grid risk. Other sensors inputting to both the EsRi Intelligence server node and the EsRi Controller will identify the failure and operational alternate electric energy flow routes to maintain reliable and safe supply and the type of failure initiating the action. The at least one EsRi controller responds based on the at least one predictive risk-informed SaRa parameter and existing real time sensed state of the electric energy grid and attached electric generation and/or storage systems.

3. The system of claim 1, wherein the instructions (for example, for building the predictive failure model) further cause the EsRi Intelligence server node to retrieve remote electric energy grid-related data from at least one remote electric energy grid database based in both historical and real time wherein the remote electric energy grid-related data is collected at locations of the electric energy grid within a pre-set distance range from the point of interconnection between the electric energy grid and the attached electric generation and/or storage systems.

4. The system of claim 3, wherein the instructions (for example, for building the predictive failure model) further cause the EsRi Intelligence server node to generate at least one feature vector based on the plurality of features, the local historical electric energy grid-related data combined with the remote electric energy grid-related data, weather, electric load and other factors.

5. The system of claim 1, wherein the instructions (for example, for determining the actions are set from the protective relaying hardware and other factors) further cause the EsRi Control processor to continuously monitor current sensory data received from the sensor arrays located on the electric energy grid and in the energy storge and generation systems) to determine if at least one reading of sensor deviates from a previous reading of the at least one sensor by a margin exceeding a pre-set threshold value (indicating a problem).

6. The system of claim 15, wherein the instructions (preloaded sequences that check operability, flow paths and other factors that impact the management of electric flow during transients) further cause the EsRi Control processor to be responsive to at least one reading deviating from the previous reading by the margin exceeding a pre-set threshold value, generate an updated feature vector based on the current sensory data and actuate at least one EsRi controller processor based on the at least one programming parameter produced by SaRa using the predictive model (created by the EsRi Intelligence server node through the use of AI in response to the updated feature vector).

7. The system of claim 1, wherein the EsRi Intelligence server node:
a. Queries multiple data sources to create an electric energy grid model, using historical data and Machine Learning (ML) develop a predictive model of electric energy grid risk in real time;
b. Query the attached energy generation and/or storage systems to create a data base of key sensory parameters that reflect the status of the energy storage systems;
c. Collect and query historical data on the performance of the attached electric generation and/or storage systems and use ML to predict its future performance;
d. Using current and historical data and Machine Learning (ML) to develop a predictive model of attached electric generation and/or storage system risk;
e. Integrate the electric energy grid risk with the attached electric generation and/or storage system risk to develop a SaRa risk profile and signal to EsRi Control;
f. SaRa collects the predictive status of the electric energy grid and interconnected systems, analyzes the information using preprogrammed rules, and provides a numerical indicator of the fragility of the system which is used by the EsRi controller to narrow the actionable choices to a specific set of preprogrammed actuator responses speeding up the response time and making the analysis simpler; and
g. Transmit the SaRa risk assessment profile signal to the EsRi Control system on a continuous basis in real time.

8. The system of claim 7, wherein the EsRi Intelligence server node instructs the EsRi Control processor as to where on the risk scale the electric energy grid and attached electric generation and/or storage systems are based on the predictive model for an automated operation of an electronic safety response interface (EsRi) controller action, comprising:
a. Receiving, by an EsRi Control processor, sensory data from one of many sensor arrays attached to an electric energy grid coupled to the EsRi Control processor and to the EsRi Intelligence server node to validate the signal (this could be, for example, a blockchain activity);
b. Parsing, by the EsRi Control processor, the sensory data to derive a plurality of features:
c. Querying, by the EsRi Intelligence server node, a local electric energy grid database to retrieve local historical electric energy grid-related data collected from the electric energy grid in real time;
d. Generating, by the EsRi Intelligence server node, at least one feature vector based on the plurality of features and the historical electric energy grid-related data; and
e. Providing, by the EsRi Intelligence server node, at least one feature vector to an ML module configured to generate a predictive model indicating at least one programming parameter for re-sequencing of the EsRi controller.

9. The method of claim 8, further comprising the generation of at least one signal to re-sequence EsRi Control based on at least one programming parameter.

10. The method of claim 9, further comprising retrieving remote electric energy grid-related data from at least one remote electric energy grid database (containing for example, voltage, current, phase angle and other sensory data) based on real time wherein the remote electric energy grid-related data is collected from a different electric energy grid located within a pre-set distance range from the electric energy grid.

11. A method for an automated re-sequencing of an electronic safety response interface (EsRi) controller receiving from an EsRi Intelligence server node, sensory data from a sensor array attached to an energy grid coupled to the EsRi controller; parsing, by the EsRi Intelligence server node, the sensory data to derive a plurality of features; querying, by the EsRi intelligence server node, a local electric energy grid database to retrieve local historical electric energy grid-related data collected from the electric energy grid date; generating, by the EsRi intelligence server node, at least one feature vector based on the plurality of features and the historical grid-related data; and providing, by the EsRi intelligence server node, the at least one feature vector to an ML module configured to generate a predictive model indicating at least one programming parameter for a SaRa risk assessment signal re-sequencing of the EsRi controller action.

12. The method of claim 11, further generating at least one signal to re-sequence the EsRi controller based on the at least one programming parameter.
A non-transitory computer readable medium comprising instructions, that when read by a processor, cause the processor to perform:
a. Receiving sensory data from a sensor array attached to an electric energy grid coupled to the EsRi controller;
b. Querying a local electric grid database to retrieve local historical electric energy grid-related data collected from the electric energy grid in real time;
c. Parsing the sensory data to derive a plurality of features;
d. Generating at least one feature vector based on the plurality of features and the historical and predictive electric energy grid-related data; and
e. Providing the at least one feature vector to an ML module configured to generate a continuous predictive model indicating at least one programming parameter for re-sequencing of the EsRi controller.

13. The method of claim 12, further comprised of retrieving remote electric energy grid-related data from at least one remote electric energy grid database based on real time, wherein the remote electric energy grid-related data is collected from a different part of the electric energy grid located within a pre-set distance range from the electric energy grid interconnection indicating transient signals.
The non-transitory computer readable medium of claim 12, further comprising instructions, that when read by the EsRi processors, that cause the processor to continuously monitor current sensory data received from the sensor array to determine if at least one reading of at least one sensor deviates from a previous reading of the at least one sensor by a margin exceeding a pre-set threshold value thus starting protective action.

14. The non-transitory computer readable medium of claim 13, further comprising instructions, that when read by the processor, cause the processor to, be responsive to at least one reading deviating from the previous reading by the margin exceeding a pre-set threshold value, generate an updated feature vector based on the current sensory data and re-sequence the EsRi controller based on the programming parameter produced by the predictive model developed through EsRi Intelligence and as used by SaRa in response to the updated feature vector.

15. The method of claim 14, further comprising continuously monitoring current sensory data received from the sensor array to determine if at least one reading of at least one sensor deviates from a previous reading of at least one sensor by a margin exceeding a pre-set threshold value.
The non-transitory computer readable medium of claim 15, further comprising instructions (for recording sensory and actuation information that provides a traceable record), that when read by the processor, cause the processor to record at least one programming parameter on a Blockchain ledger along with the sensory data; and retrieve at least one programming parameter from the Blockchain responsive to a consensus among electric energy grid authority entities.

16. The method of claim 14, further comprising, responsive to the at least one reading deviating from the previous reading by the margin exceeding a pre-set threshold value, generating an updated feature vector based on the current sensory data and re-sequencing the EsRi controller based on at least one programming parameter produced by the predictive model as signaled through the SaRa risk assessment in response to the updated feature vector.
The system of claim 16, wherein the instructions further cause the EsRi Intelligence server node to record at least one programming parameter on a Blockchain ledger along with the sensory data.

17. A non-transitory computer readable medium comprising instructions, that when read by a processor, cause the processor to perform: receiving sensory data from a sensor array attached to an electric energy grid coupled to the EsRi controller; parsing the sensory data to derive a plurality of features; querying a local electric energy grid database (for example, voltage, current, phase angle, etc.) to retrieve local historical electric energy grid-related data collected from the electric energy grid based on real time; generating at least one feature vector based on the plurality of features and the historical electric energy grid-related data; and providing the at least one feature vector to an ML module configured to generate a predictive model indicating at least one programming parameter for re-sequencing of the EsRi controller through the SaRa risk signal.
The system of claim 8, wherein the instructions further cause the EsRi Intelligence server node to retrieve at least one programming parameter from the Blockchain responsive to a consensus among electric energy grid authority entities.

18. The non-transitory computer readable medium of claim 17, further comprising instructions (for example preprogrammed protective relaying responses to various failure modes), that when read by the EsRi processor, cause the processor to continuously monitor current sensory data received from the sensor array to determine if at least one reading of at least one sensor deviates from a previous reading of the at least one sensor by a margin exceeding a pre-set threshold value.
The system of claim 8, wherein the instructions further cause the EsRi Control processor to retrieve at least one programming parameter from the Blockchain responsive to a consensus among energy authority entities.

19. The non-transitory computer readable medium of claim 18, further comprising instructions, that when read by the processor, cause the processor to be responsive to the at least one reading deviating from the previous reading by the margin exceeding a pre-set threshold value, generate an updated feature vector based on the current sensory data and re-sequencing the EsRi controller based on the at least one programming parameter produced by the SaRa risk signal in response to the updated feature vector.
The system of claim 1 that allows the more rapid response of the protective system while maintaining flow from the operable interconnected electric generation and/or storage systems based on the electric energy grid stability provides the system planner better information and the electric energy grid operator a more reliable connected resource.

20. The non-transitory computer readable medium of claim 19, further comprising instructions (for example to match the real time data to synchronize the risk signal to the current sensory data), that when read by the processor, cause the processor to: record the at least one programming parameter on a blockchain ledger along with the sensory data; and retrieve the at least one programming parameter from the Blockchain responsive to a consensus among energy authority entities.
